(19) United States
(12) Patent Application Publication
(10) Pub. No.: US 2008/0122878 A1
(43) Pub. Date: May 29, 2008

(54) Apparatus and method for publishing computer-readable media

(76) Inventors: Gary W. Keefe, Brecksville, OH (US); Peter J. Adam, Kirkland, WA (US); Richard M. Edwards, Akron, OH (US); Peter O. Botten, Lakewood, OH (US); Alan J. Gilbert, Hudson, OH (US); Gary W. Enos, Hudson, OH (US); Michael Kolberg, Hinckley, OH (US); Michael V. Lustig, Sissonville, WV (US)

Correspondence Address: BROUSE MCDOWELL LPA, 388 SOUTH MAIN STREET, SUITE 500, AKRON, OH, 44311, US

(21) Appl. No.: 11/604,097

(22) Filed: Nov. 24, 2006

(51) Int. Cl. G06F 17/00

(52) U.S. Cl. 346/19; 700/90

(57) ABSTRACT

A method and apparatus for recording electronic data onto a portable computer-readable medium to be given to an end user for allowing the end user to review the electronic data in a private setting with a personal computer. The publisher includes a recorder for recording the electronic data on the portable computer-readable medium, an automated feeder for supplying the portable computer-readable medium to the recorder without intervention by an operator, and a user interface presenting the operator with one or more options that the operator can select to enter a command for controlling operation of the publisher. A printer is provided for printing onto a surface of a label at least variable label content that is related to the electronic data that can be retrieved from the computer-readable medium and reviewed by the end user. A control unit controls the recording of the electronic data onto the portable computer-readable medium by the recorder, and a communication interface is operatively coupled to the control unit for communicating the electronic data to the publisher. A computer-accessible memory unit is operatively coupled to the publisher for storing computer-executable instructions to be executed for performing a method of publishing a computer-readable medium.

### BACKGROUND OF THE INVENTION

1. Field of the Invention

The present invention is directed generally to a method and apparatus for recording data onto a computer-readable memory, and more specifically, to a record management system for rapidly recording electronic files onto a computer-readable memory customized for the intended end user.

2. Description of Related Art

Typically, patients visit a physician when the patient experiences symptoms that are believe to be indicative of a potential medical ailment or condition. To determine what, if any, medical conditions exist the physician usually conducts a series of tests that collectively make up a diagnostic study in an effort to diagnose and effectively treat the condition. For example, a diagnostic study can include tests such as chemical analysis or other laboratory work on bodily fluids and tissue samples collected from the patient, medical images such as x-rays and CT scans that offer the physician a non-invasive look into the patient's body, and other such tests. Each study can also include a series of laboratory results, medical images, etc. . . . taken over a period of time. This time period can range from days, to weeks, months or even years to track the progress of medical treatments administered to address a diagnosed medical condition and to ensure that a treated medical condition has not subsequently returned.

The primary method of documenting and recording medical studies in the past required filing large volumes of diagnostic and other medical studies in a paper file for each patient. Such systems required significant storage facilities to keep the hardcopies for each patient for the mandatory storage period required of medical institutions. Additionally, to provide a patient with a copy of all or part of their file, including any specific study, the file would have to be retrieved from the storage facility and a hardcopy made for the patient. This process of archiving studies and medical records is costly for the medical institution, and exposes the records to loss or damage each time they are retrieved. Further, for off-site storage facilities immediate access to archived medical studies is available, thereby substantially delaying the retrieval and optional copying of the studies.

As computers evolved, it has become practical to store medical studies in an electronic format on a computer-readable medium such as a local hard drive, remotely-located hard drive provided to a server, or other suitable medium. Additionally, networking developments allowed chemical analysis machines and medical imaging machines such as x-ray machines and CT scanning machines to be operatively connected to the storage medium. Thus, as tests or imaging operations are conducted, the results can be saved directly to the computer-readable medium, from where they could later be retrieved. Saving medical studies to a computer-readable medium has also facilitated the remote retrieval and storage of the studies.

However, to provide a physician or the patient with a hardcopy of a study, the electronic files forming the study stored on the computer-readable medium are typically retrieved and published using the chemical or imaging machines themselves. Otherwise, a staff member seated at a conventional workstation at the medical institution can manually retrieve the study files and print them, or save them on a disk to be given to the physician or patient. The workstation is merely a conventional personal computer equipped with a central processing unit, memory, visual display and a variety of peripherals to interface with the staff member. But since such workstations are utilized by those on staff at the medical institution for other office business, this other office business must be disrupted to so retrieve and publish the study files. Further, the staff member is preoccupied while manually overseeing each step of the process of producing the study files in a portable format for the physician or patient.

Previous attempts have also been made to offer the study files to patients in an electronic format so the patients can review the study files in the privacy of their own home. Typically, the electronic study files are accessible to patients over a wide area network such as the Internet. However, for patients without access to a high-speed Internet connection, viewing rather large image files, for example, is difficult and very time consuming. Further, image files and the output from a chemical analysis instrument typically come in a proprietary format that is designed to enhance the utility of the images and other output for medical-diagnosis purposes. As such, these files are typically only viewable with a proprietary application at the medical facility that is not available to the patient, nor licensed for use to allow the patients to access their files over the Internet.

Accordingly, there is a need in the art for an electronic file publishing method and apparatus for storing electronic files on a computer-readable medium to be viewed by an end user in a private setting. The personal message device can include a custom label printer for identifying the contents of the computer-readable medium, and can operate independently of a conventional workstation to minimize use of the workstation resources. Further, the publishing apparatus and method automate the process of publishing an electronic study file to a portable format to be given to an end user.

### BRIEF SUMMARY OF THE INVENTION

According to one aspect, the present invention provides a publisher for recording electronic data onto a portable computer-readable medium to be given to an end user for allowing the end user to review the electronic data in a private setting. The publisher comprises a recorder for recording the electronic data on the portable computer-readable medium, an automated feeder for supplying the portable computer-readable medium to the recorder without intervention by an operator, and a user interface for visibly displaying options available to the operator for controlling operation of the publisher. A printer is included for printing onto a surface of a label at least variable label content that is related to the electronic data that can be retrieved from the computer-readable medium and reviewed by the end user, and a control unit is included to control the recording of the electronic data onto the computer-readable medium by the recorder. The publisher further comprises a communication interface operatively coupled to the control unit for communicating the electronic data to the publisher, and a computer-accessible memory unit operatively coupled to the publisher and storing computer-executable instructions. The computer-executable instructions are executable by the control unit for performing a method comprising the steps of determining a quantity of the variable label content to be printed on the label, and selecting an appropriate label from a plurality of available labels each having different fixed label content as a function of at least the quantity of the variable label content to be printed on the label.

According to another aspect, the present invention provides a computer-readable medium comprising computer-executable instructions for performing a method of printing a label related to electronic data stored on a portable computer-readable medium. The method comprises the steps of determining a quantity of variable label content specific to the end user to be printed on the label and selecting an appropriate label from a plurality of available labels having different fixed label content as a function of at least the quantity of the variable label content to be printed on the label.

According to another aspect, the present invention provides a publisher for recording electronic data onto a portable computer-readable medium to be given to an end user for allowing the end user to review the electronic data in a private setting with a personal computer. The publisher comprises a communication interface operatively coupled to the control unit for communicating the electronic data to the publisher, a recorder for recording the electronic data on the portable computer-readable medium, an automated feeder for supplying the portable computer-readable medium to the recorder from a supply bin without intervention by an operator, and a user interface for visibly displaying options that the operator can select to control operation of the publisher. The publisher further comprises a printer for printing onto a surface of the portable computer-readable medium at least variable label content related to the electronic data that can be retrieved from the computer-readable medium and reviewed by the end user, a control unit to control the recording of the electronic data onto the portable computer-readable medium by the recorder, and a computer-accessible memory unit operatively coupled to the publisher and storing computer-executable instructions for performing a method. The method comprises the steps of evaluating an orientation of the portable computer-readable medium introduced to the printer to identify a location of fixed label content preprinted on the surface of the portable computer-readable medium, determining a location of an available region on the surface of the portable computer-readable medium on which the variable label content is to be printed based at least in part on the location of the fixed label content, and initiating printing of the variable label content on the available region on the surface of the portable computer-readable medium.

According to yet another aspect, the present invention provides a computer-readable medium comprising computer-executable instructions for performing a method of printing on a surface of a portable computer-readable memory variable label content related to data stored on the portable computer-readable medium. The method comprises the steps of evaluating an orientation of the portable computer-readable medium as introduced to a printer to identify a location of fixed label content preprinted on the surface of the portable computer-readable medium, determining a location of an available region on the surface of the computer-readable medium on which the variable label content is to be printed based at least in part on the location of the fixed label content, and initiating printing of the variable label content on the available region on the surface of the computer-readable medium.

According to yet another aspect, the present invention provides a publisher for recording electronic data onto a portable computer-readable medium to be given to an end user for allowing the end user to review the electronic data in a private setting with a personal computer. The publisher comprises a recorder for recording the electronic data on the portable computer-readable medium, an automated feeder for supplying the portable computer-readable medium to the recorder without intervention by an operator, a user interface for visibly displaying options available to the operator for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the computer-readable medium by the recorder, a communication interface operatively coupled to the control unit for communicating the electronic data to the publisher, and a computer-accessible memory unit operatively coupled to the publisher and storing computer-executable instructions for performing a method. The method comprises the steps of establishing a status of the end user and selecting an appropriate fixed label content based at least in part on the status of the end user.

According to yet another aspect, the present invention provides a computer-readable medium comprising computer-executable instructions for performing a method of printing on a surface of a label variable label content related to electronic data stored on a portable computer-readable medium. The method comprises the steps of establishing a status of an intended end user of the electronic data on the portable computer-readable medium and selecting an appropriate fixed label content based at least in part on the status of the end user.

According to yet another aspect, the present invention provides a publisher for recording electronic data onto a portable computer-readable medium to be given to an end user for allowing the end user to review the electronic data with a personal computer in a private setting. The publisher comprises a recorder for recording the electronic data on the portable computer-readable medium, an automated feeder for supplying the portable computer-readable medium to the recorder without intervention by an operator, a user interface for visibly displaying options available to the operator for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the computer-readable medium by the recorder, a communication interface operatively coupled to the control unit for communicating the electronic data to the publisher, a memory interface for receiving a memory module storing third-party computer-executable instructions that facilitate the review of the electronic data by the end user with the personal computer, and a computer-accessible memory unit operatively coupled to the publisher and storing computer-executable instructions for performing a method. The method comprises the steps of searching a predetermined directory of the memory module for selected third-party computer-executable instructions stored by the memory module that facilitate the review of the electronic data with the personal computer, and recording the selected third-party computer-executable instructions onto the portable computer-readable medium.

According to yet another aspect, the present invention provides a method of recording electronic data onto a portable computer-readable medium to be reviewed by an end user in a private setting with a personal computer. The method comprises the steps of retrieving the electronic data to be recorded onto the portable computer-readable medium and transmitting the electronic data to a publisher, searching a predetermined directory of a memory module that is removably coupled to the publisher for suitable third-party computer-executable instructions that facilitate the review of the electronic data with the personal computer, and recording the suitable third-party computer-executable instructions and the electronic data onto the portable computer-readable medium.

According to yet another aspect, the present invention provides a publisher for recording electronic data stored on a remotely located server onto a portable computer-readable medium to be given to an end user for allowing the end user to review the electronic data with a personal computer in a private setting. The publisher comprises a recorder for recording the electronic data on the portable computer-readable medium, an automated feeder for supplying the portable computer-readable medium to the recorder without intervention by an operator, a user interface for visibly displaying options available to the operator for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the computer-readable medium by the recorder, a communication interface operatively coupled to the control unit for communicating the electronic data received from the remotely located server to the publisher, and a computer-accessible memory unit operatively coupled to the publisher and storing computer-executable instructions for performing a method. The method comprises the steps of determining when the transfer of the electronic data from the remotely located server is complete without waiting for a timeout period to expire, and commencing the recording of the electronic data upon completion of the transfer of the electronic data from the remotely located server.

According to yet another aspect, the present invention provides a computer-readable medium comprising computer-executable instructions for performing a method of recording electronic data stored on a remotely located server onto a portable computer-readable media. The method comprises the steps of initiating communication of the electronic data from the remotely located server to a computer-readable media publisher, determining when the communication of the electronic data from the remotely located server to the publisher is complete without waiting for a timeout period to expire, and commencing the recording of the electronic data upon completion of the transfer of the electronic data from the remotely located server.

According to yet another aspect, the present invention provides a publisher for recording electronic data onto a portable computer-readable medium to be given to an end user for allowing the end user to review the electronic data in a private setting. The publisher comprises a recorder for recording the electronic data on the portable computer-readable medium, an automated feeder for supplying the portable computer-readable medium to the recorder without intervention by an operator, a user interface presenting the operator with one or more options that the operator can select to enter a command for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the portable computer-readable medium by the recorder, a communication interface operatively coupled to the control unit for communicating the electronic data to the publisher, and a recording interface for establishing a communication path between the publisher and an external recording device for substantially-continuously recording the electronic data onto the external recording device as the electronic data is communicated to the publisher.

According to yet another aspect, the present invention provides a method of recording electronic data onto a portable computer-readable medium to be given to an end user for allowing the end user to review the electronic data in a private setting. The method comprises the steps of communicating the electronic data to be recorded onto the portable computer-readable medium to a computer-readable media publisher, supplying the portable computer-readable medium to a recorder of the publisher automatically and without intervention by an operator, recording the electronic data onto the portable computer-readable medium upon receiving a record command from the operator, and substantially-continuously recording the electronic data onto an external recording device automatically as the electronic data is communicated to the publisher without intervention by the operator.

According to yet another aspect, the present invention provides a publisher for recording electronic data onto a portable computer-readable medium to be given to an end user for allowing the end user to review the electronic data in a private setting with a personal computer. The publisher comprises a recorder for recording the electronic data on the portable computer-readable medium, an automated feeder for supplying the portable computer-readable medium to the recorder without intervention by an operator, a touch-screen interface visually displaying to the operator one or more options that the operator can select by contacting the touch-screen interface to enter a command for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the portable computer-readable medium by the recorder, and a communication interface operatively coupled to the control unit for communicating the electronic data to the publisher.

According to yet another aspect, the present invention provides a publisher for recording electronic data onto a portable computer-readable medium to be given to an end user for allowing the end user to review the electronic data in a private setting with a personal computer. The publisher comprises a recorder for recording the electronic data on the portable computer-readable medium, an automated feeder for supplying the portable computer-readable medium to the recorder without intervention by an operator, a user interface presenting the operator with one or more options that the operator can select to enter a command for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the portable computer-readable medium by the recorder, and a communication interface operatively coupled to the control unit for communicating the electronic data to the publisher. The recorder, automated feeder, user interface and control unit are vertically stacked and integrally formed as a single unit according to such an aspect of the present invention to minimize a surface area upon which the publisher rests.

According to yet another aspect, the present invention provides a publisher for recording electronic data onto a portable computer-readable medium to be given to an end user for allowing the end user to review the electronic data in a private setting with a personal computer. The publisher comprises a recorder for recording the electronic data on the portable computer-readable medium, an automated feeder for supplying the portable computer-readable medium to the recorder without intervention by an operator, a user interface presenting the operator with one or more options that the operator can select to enter a command for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the portable computer-readable medium by the recorder, a communication interface operatively coupled to the control unit for communicating the electronic data to the publisher, and an image printer for printing a hardcopy of an image represented by the electronic data.

According to yet another aspect, the present invention provides a publisher for recording electronic data onto a portable computer-readable medium to be given to an end user for allowing the end user to review the electronic data in a private setting with a personal computer. The publisher comprises a recorder for recording the electronic data on the portable computer-readable medium, an automated feeder for supplying the portable computer-readable medium to the recorder without intervention by an operator, a user interface presenting the operator with one or more options that the operator can select to enter a command for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the portable computer-readable medium by the recorder, a communication interface operatively coupled to the control unit for communicating the electronic data to the publisher, and a computer-accessible memory unit operatively coupled to the publisher and storing computer-executable instructions for performing a method. The method comprises the steps of affiliating a label format to be printed onto the label with a job profile selected by the operator, affiliating site-specific label content with a site profile referenced by the job profile selected by the operator that corresponds to a facility from which the electronic data is communicated to the publisher, and initiating printing of both the label format corresponding to the selected job profile and the site-specific label content and the fixed label content onto the label.

According to yet another aspect, the present invention provides a publisher for recording electronic data onto a portable computer-readable medium to be given to an end user for allowing the end user to review the electronic data in a private setting with a personal computer. The publisher comprises a recorder for recording the electronic data on the portable computer-readable medium, an automated feeder for supplying the portable computer-readable medium to the recorder without intervention by an operator, and a user interface presenting the operator with one or more options that the operator can select to enter a command for controlling operation of the publisher. The user interface presents the operator with a quick record option which, when selected, initiates printing of the electronic data without further intervention by the operator. The publisher further comprises a printer for printing onto a surface of a label at least variable label content that is related to the electronic data that can be retrieved from the computer-readable medium and reviewed by the end user, a control unit to control the recording of the electronic data onto the portable computer-readable medium by the recorder, and a communication interface operatively coupled to the control unit for communicating the electronic data to the publisher.

According to yet another aspect, the present invention provides a publisher for recording electronic data onto a portable computer-readable medium to be given to an end user for allowing the end user to review the electronic data in a private setting with a personal computer. The publisher comprises a recorder for recording the electronic data on the portable computer-readable medium, an automated feeder for supplying the portable computer-readable medium to the recorder without intervention by an operator, a user interface presenting the operator with one or more options that the operator can select to enter a command for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the portable computer-readable medium by the recorder, a communication interface operatively coupled to the control unit for communicating the electronic data to the publisher, and a computer-accessible memory unit operatively coupled to the publisher and storing computer-executable instructions for performing a method. The method comprises the steps of initiating printing of orientation-independent fixed label content onto the surface of the label, and initiating printing of the variable label content onto the surface of the label without regard to an orientation of the computer-readable medium during printing.

According to yet another aspect, the present invention provides a publisher for recording electronic data onto a portable computer-readable medium to be given to an end user for allowing the end user to review the electronic data in a private setting with a personal computer. The publisher comprises a recorder for recording the electronic data on the portable computer-readable medium, an automated feeder for supplying the portable computer-readable medium to the recorder without intervention by an operator, a user interface presenting the operator with one or more options that the operator can select to enter a command for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the portable computer-readable medium by the recorder, a communication interface operatively coupled to the control unit for communicating the electronic data to the publisher, and a computer-accessible memory unit operatively coupled to the publisher and storing computer-executable instructions for performing a method. The method comprises the steps of initiating recording of the electronic data onto the portable computer-readable medium, and initiating recording of computer-executable logic onto the portable computer-readable medium for causing the personal computer to display promotional material to the end user.

According to yet another aspect, the present invention provides a publisher for recording electronic data onto a portable computer-readable medium to be given to an end user for allowing the end user to review the electronic data in a private setting with a personal computer. The publisher comprises a recorder for recording the electronic data on the portable computer-readable medium, an automated feeder for supplying the portable computer-readable medium to the recorder without intervention by an operator, a user interface presenting the operator with one or more options that the operator can select to enter a command for controlling operation of the publisher, and a printer for printing onto a surface of a label at least variable label content that is related to the electronic data that can be retrieved from the computer-readable medium and reviewed by the end user. The publisher further comprises a control unit to control the recording of the electronic data onto the portable computer-readable medium by the recorder, a communication interface operatively coupled to the control unit for communicating the electronic data to the publisher, and a computer-accessible memory unit operatively coupled to the publisher and storing computer-executable instructions for performing a method. The method comprises the steps of analyzing electronic data forming a portion of a study that has been communicated to the publisher from a remotely-located server to identify the study, and requesting the electronic data of the study from the remotely-located server.

### BRIEF DESCRIPTION OF THE DRAWINGS

The invention may take physical form in certain parts and arrangement of parts, embodiments of which will be described in detail in this specification and illustrated in the accompanying drawings which form a part hereof, and wherein:

FIG. 1 is a perspective view showing a computer-readable medium publisher in accordance with an embodiment of the present invention;

FIG. 2 is a cutaway view of a portion of a computer-readable medium publisher with a protective cover removed in accordance with an embodiment of the present invention;

FIG. 3 is an exploded view of a portion of a computer-readable medium publisher in accordance with an embodiment of the present invention;

FIG. 4 is an assembled view of a portion of a computer-readable medium publisher in accordance with an embodiment of the present invention;

FIG. 5 is a perspective view of a portion of a computer-readable medium publisher with a published media receiver removed to expose a memory module operatively coupled to a memory-module interface;

FIG. 6 is a block diagram illustrating an arrangement of an embodiment of a control unit operable to control operation of the computer-readable medium publisher;

FIG. 7 is an embodiment of a general publication method of publishing a portable computer-readable medium in accordance with an embodiment of the present invention;

FIG. 8 shows an alternate embodiment of a method of receiving electronic data that eliminates the need for a lengthy timeout period to indicate that all electronic data for a complete study has been received;

FIG. 9 is an illustrative arrangement of soft keys and other control features by a touch-screen display panel as the user interface in accordance with an embodiment of the present invention;

FIG. 10 illustrates method steps to be initiated or otherwise implemented by a control unit executing computer-executable instructions in accordance with an embodiment of the present invention to record third-party software onto a portable computer-readable medium;

FIG. 11 illustrates method steps to be initiated or otherwise implemented by a control unit executing computer-executable instructions in accordance with an embodiment of the present invention to select a suitable label design onto which variable label content is to be printed;

FIG. 12a is a top view looking down onto a portable computer-readable medium including fixed label content and passages of variable label content printed in accordance with an embodiment of the present invention;

FIG. 12b is a top view looking down onto a portable computer-readable medium including fixed label content and passages of variable label content printed in accordance with an embodiment of the present invention;

FIG. 13 is a graphical illustration of a method of printing a label for a portable computer-readable medium based at least in part on an intended recipient of the portable computer-readable medium;

FIG. 14a is a top view looking down onto a printed label provided to an optical portable computer-readable medium in a normalized orientation;

FIG. 14b is a top view looking down onto a printed label provided to an optical portable computer-readable medium in an angled orientation;

FIG. 15 illustrates method steps to be initiated or otherwise implemented by a control unit executing computer-executable instructions in accordance with an embodiment of the present invention to establish a suitable angular orientation of variable label content to be printed onto a label relative to fixed label content on the label;

FIG. 16 illustrates method steps to be initiated or otherwise implemented by a control unit executing computer-executable instructions in accordance with an embodiment of the present invention to request electronic data from a remotely-located server;

FIG. 17 shows an optical portable computer-readable medium including passages of variable label content and orientation-independent fixed label content;

FIG. 18 illustrates method steps to be initiated or otherwise implemented by a control unit executing computer-executable instructions in accordance with an embodiment of the present invention to provide variable label content and orientation-independent fixed label content to a label of a portable computer-readable medium; and

FIG. 19 shows an illustrative embodiment of a dialog box displayed by a monitor provided to a personal computer in response to the execution of computer-executable instructions recorded onto a portable computer-readable medium along with electronic data, wherein the dialog box displays promotional materials to an end user of the electronic data retrieved from the portable computer-readable medium.

### DETAILED DESCRIPTION OF ILLUSTRATIVE EMBODIMENTS

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

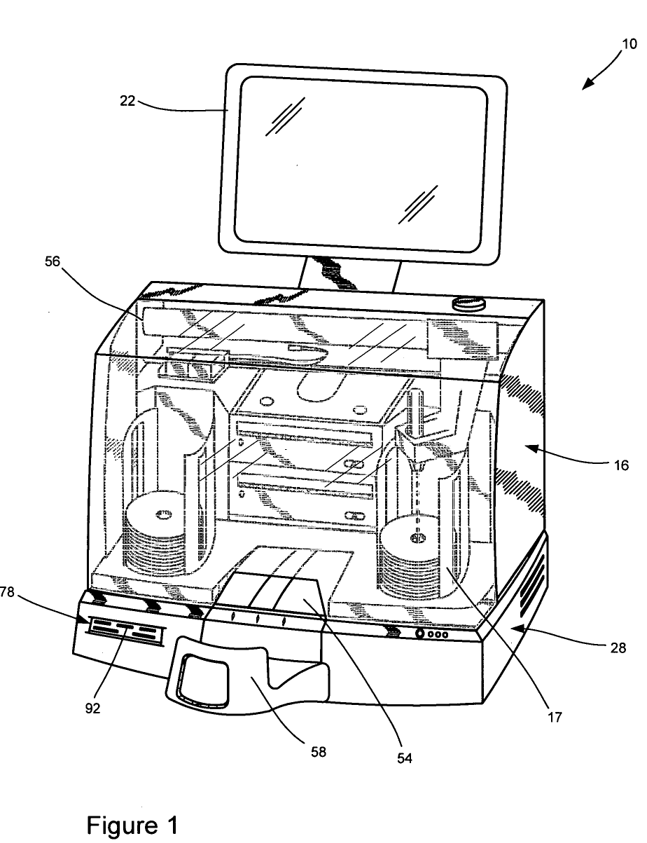

FIG. 1 shows an illustrative embodiment of a computer-readable-media publisher 10 in accordance with an embodiment of the present invention. Although such a publisher 10 can be utilized in any field in which it is desirable to record electronic data onto one or more portable computer readable media, the embodiments of the present invention are described below as being used in the medical field for the sake of clarity. Accordingly, electronic data are not limited to electronic data representing medical images, charts, files, and the like, that make up a medical study as described below as described in the illustrative embodiments. The electronic data to be recorded onto the computer-readable medium can represent any electronic file, document, image, audio file, video file, and other such files that can be reviewed with a personal computer.

Similarly, the end user can be any intended recipient of the electronic data, examples of which include customers, patients, insurance companies, physicians, teaching faculty, and so on. But again, to clearly and concisely describe the illustrative embodiments of the present invention, the end user will also be referred to below with reference to the medical field. As such, the end user can be a person affiliated with a medical facility, such as a radiologist or other caregiver administering treatment of a medical condition. Alternately, the end user can be a patient who received care from the radiologist or other caregiver affiliated with the medical facility, and who is to be given the computer readable medium storing the electronic data specific to the treatment of that particular patient.

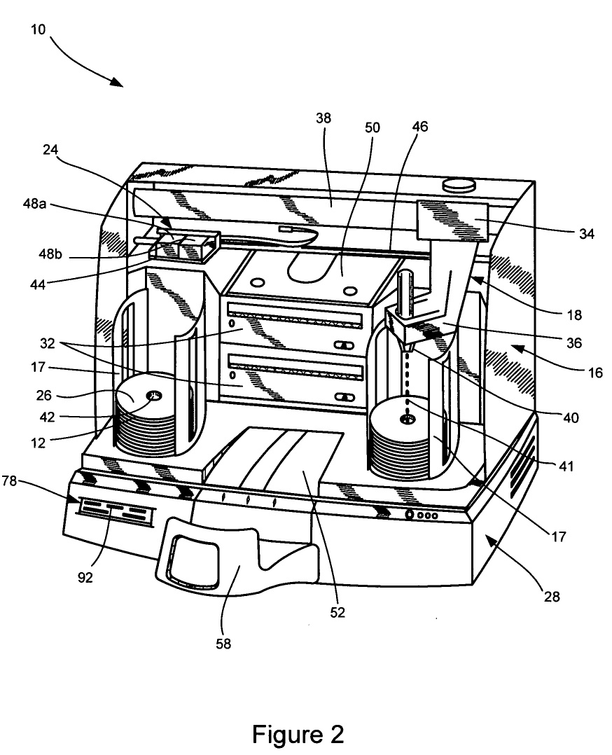

With continued reference to FIG. 1 and now to FIG. 2 as well, the publisher 10 records the electronic data onto the portable computer-readable medium 12 to be given to the end user. The end user can subsequently retrieve and review the electronic data from the computer-readable medium 12 in a private setting such as the patient's home, or the radiologist's office, with a personal computer. As shown in FIGS. 1 and 2, the publisher 10 comprises a recorder 16 for recording the electronic data onto the portable computer-readable medium 12, and an automated feeder 18 for transporting the portable computer-readable medium 12 from a storage bin 17 to the recorder 16 without intervention by an operator. That is, once a record command has been entered by the operator of the publisher 10 as described in detail below, the automated feeder 18 supplies the computer-readable medium 12 retrieved from the storage bin 17 to the recorder 16 without further intervention by the operator.

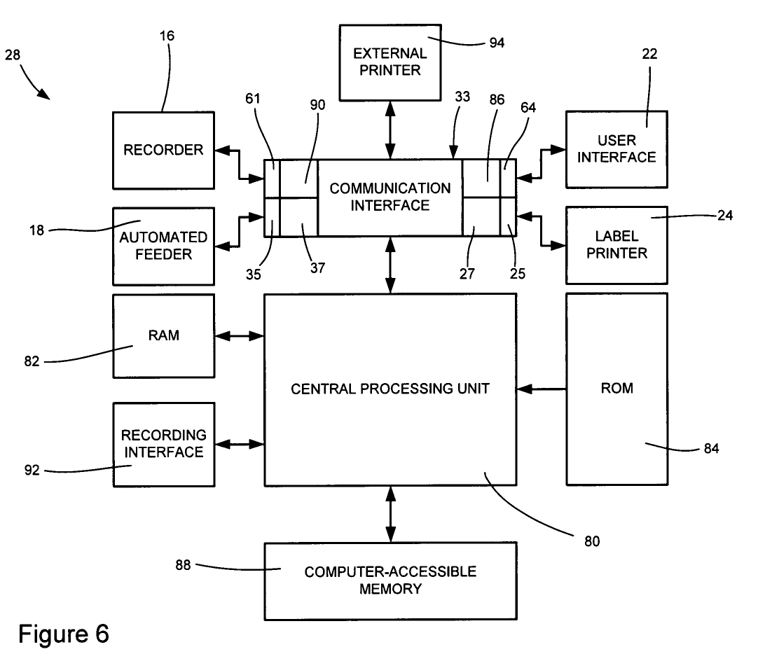

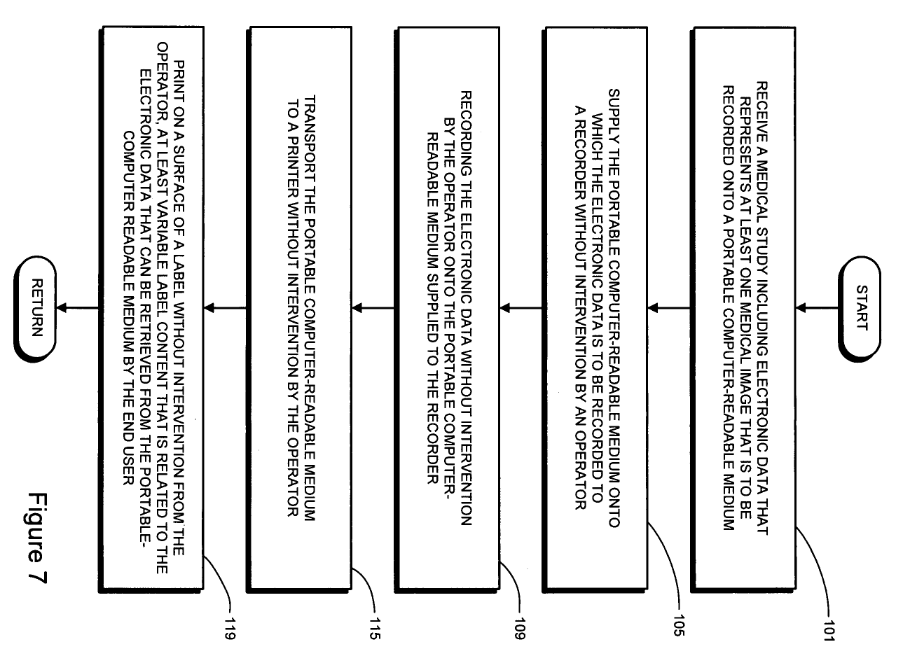

In addition to the recorder 16 and automated feeder 18, the publisher 10 further comprises a user interface 22 (also referred to herein for some embodiments as a touch-screen display panel 22) presenting the operator with one or more options that the operator can select to enter a command for controlling operation of the publisher 10 as described in detail below. A printer 24 is provided for printing onto a surface of a label 26 at least variable label content that is related to the electronic data that can be retrieved from the portable computer-readable medium 12 and reviewed by the end user. A control unit 28 to control the recording of the electronic data onto the portable computer-readable medium by the recorder. The control unit 28 optionally also controls printing of the label content onto the surface of the label 26. Additionally, a communication interface 33 (FIGS. 3 and 6) is operatively coupled to the control unit 28 for communicating the electronic data to the publisher 10 to be recorded onto the computer-readable medium 12.

The computer-readable medium 12 is said to be portable in that it is a mass storage medium that can be used to store information according to a standard that enables the end user to retrieve and review the electronic data with computers other than the publisher 10 itself. In other words, the portable computer-readable medium 12 is a passive medium that can be temporarily inserted into a compatible drive unit of a personal computer for retrieving and reviewing the electronic data there from. The computer-readable medium 12 is acted upon by the publisher 10 or reviewing computer, and does not need its own power supply for operation. Examples of suitable portable computer-readable media 12 include, but are not limited to, optical media such as a compact disc (also referred to as a “CD” and “CD-ROM”), digital video disc (also referred to as a “digital versatile disc,” “DVD” and “DVD-ROM”).

The recorder 16 includes one or more recording bays 32 that are compatibly adapted to record electronic data onto the portable computer-readable media 12 to be given to the end user. For embodiments utilizing an optical computer-readable medium 12 such as a CD or DVD, each recording bay 32 is independently selected from the group consisting of a CD writer drive, a DVD writer drive, and a combination CD/DVD writer drive. The CD and DVD writers record data onto a data side of a CD and DVD, respectively, by impinging laser light from a laser source onto said data side. The laser light forms a pattern on the data side of the CD and DVD, optionally on a plurality of different layers of the CD and DVD, thereby recording the electronic data onto the CD and DVD. As the name suggests, the combination CD/DVD writer drive is adaptive for recording electronic data onto both a CD and a DVD.

For the illustrative embodiment shown in FIG. 2, the recorder 16 includes two recording bays 32. Each of the recording bays 32 in FIG. 2 can be independently selected as a CD writer drive, DVD writer drive, or a combination CD/DVD writer drive. Thus, the recorder 16 can include two CD writer drives, two DVD writer drives, two CD/DVD writer drives, or any combination of CD, DVD and CD/DVD writer drives. Further, the recorder 16 can suitably be provided with any number of recording bays 32 to record electronic data onto optical computer-readable media 12 as appropriate.

The automated feeder 18 of the publisher 10 retrieves a suitable portable computer-readable medium 12 from a supply bin 17 to be inserted into one of the recording bays 32 from where the electronic data can be recorded. Each supply bin 17 can be an open column approximating the diameter of an optical computer-readable medium 12 that is defined by one or more plastic partitions. Although the automated feeder 18 can include any device that is autonomously-driven according to the execution of computer-executable logic, an example of a suitable automated feeder 18 includes a robotic arm 36 that can be positioned at a plurality of locations along a track 38. According to such embodiments, a drive motor 34 is activated according to the instructions from the computer-executable logic to adjust the position of an outwardly extending arm 36 along a transverse track 38. The automated feeder 18 can optionally be operatively coupled to a plug 35 of a driver card 37 (FIG. 6) in communication with the communication interface 33 to receive control commands from the control unit 28. The arm 36 can be positioned over two supply bins 17 storing the portable computer-readable media 12 such that a medium grasping tool 40 is generally aligned with a central axis 41 of an aperture 42 formed in each portable computer-readable medium 12. Once properly aligned, the grasping tool 40 can be lowered into the bin 17 and into the aperture 42 of the portable computer-readable medium 12 to be inserted into one of the recording bays 32. A diameter of the grasping tool 40 can be enlarged once inside the aperture 42 to secure the portable computer-readable medium 12 to the feeder 18.

With the portable computer-readable medium 12 secured to the feeder 18, the grasping tool 40 along with the portable computer-readable medium 12 is elevated out of the storage bin 17. The position of the arm 36 is then adjusted along the transverse track 38 toward the recording bay 32 into which the portable computer-readable medium 12 is to be inserted. A door of the recording bay 32 is opened to allow a supporting tray (not shown) to be extended out of the recording bay 32 for receiving the portable computer-readable medium 12 in a manner known in the art. Once the portable computer-readable medium 12 is supported above the extended supporting tray, the diameter of the grasping tool 40 can be reduced to allow the aperture 42 of the portable computer-readable medium 12 to pass over the grasping tool 40. This results in the portable computer-readable medium 12 falling onto the supporting tray, which is then retracted back into the recording bay 32.

For embodiments where the electronic data are to be recorded onto different portable computer-readable media 12, each different media can be stored in a separate storage bin 17. Thus, there can optionally be as many storage bins 17 as there are different types of portable computer-readable media 12. Further, the storage bin 17 in which each known type of portable computer-readable media 12 is stored can be programmed into a computer-accessible memory provided to the publisher 10 as described below. Thus, the automated feeder 18 can selectively retrieve a suitable type of portable computer-readable media 12 for a given recording of electronic data.

For example, the price of portable computer-readable media 12 can vary based on the finish of a surface of a label 26 provided to the portable computer-readable media 12. Flat label finishes that are substantially non-reflective are relatively inexpensive relative to glossy finishes, which have a shine that makes them appear to be at least partially reflective. Glossy finishes offer a viewer a professional finish that is very appealing for marketing purposes. The glossy finishes are typically to be reserved for end users not affiliated with the medical facility responsible for recording the electronic data, and marketing material may be printed on such a label 26 to be disseminated outside of the medical facility in addition to material identifying the end user or the electronic data recorded on the respective portable computer-readable medium 12.

In contrast, there is no need to include marketing material on a copy of the portable computer-readable medium 12 to be given to a physician who is going to simply review the electronic data regarding a patient since the physician is affiliated with the medical facility. Thus, publishing costs can be minimized by recording the electronic data onto the portable computer-readable medium 12 for the physician that is provided with a flat-finish label 26.

This example is also illustrative of a distinction between fixed label content and variable label content. Fixed label content is used herein to refer to any visual indicia provided to the label 26 of the portable computer-readable medium 12 that is not specific to the electronic data recorded on that portable computer-readable medium 12. For example, marketing or promotional material for a particular medical facility or division thereof that is either pre-printed onto the label 26 or printed by the publisher 10 onto the label 26 is considered fixed label content. Likewise, the name, address, and other fixed contact information of the medical facility publishing the portable computer-readable medium 12, or furnishing the electronic data to be recorded would also be considered to be fixed label content.

In contrast, variable label content is the material to be printed onto the label 26 provided to the portable computer-readable medium 12 by the publisher 10 during the publication process performed by the portable computer-readable medium 12 described below. The variable label content is specific to the end user, the electronic data recorded onto the portable computer-readable medium 12, or a combination thereof. While the fixed label content can optionally be the same for a plurality of portable computer-readable media 12 published with the publisher 10 that are each to be distributed to different end users, the variable label content serves to differentiate each portable computer-readable medium 12 storing different electronic data. Examples of such variable label content include, but are not limited to, a patient's name, address, patient identification number, subject of the electronic data, the number of each portable computer-readable medium 12 in a series, patient visit date, patient discharge date, the date on which the medical study was performed, the name of the patient's primary physician, the physician conducting the particular study recorded onto the portable computer-readable medium 12, any other patient or electronic-data specific information, and any combination thereof.

The printer 24 prints onto a surface of the label 26 at least the variable label content. As mentioned above, the variable label content is related to the electronic data that can eventually be retrieved from the computer-readable medium and reviewed by the end user after the portable computer-readable medium 12 is ejected from the publisher 10. The printer can optionally print only the variable label content onto a glossy finish label 26, only the variable label content onto a flat finish label 26, both the variable label content and the fixed label content onto a flat finish label 26, or both the variable label content and the fixed label content onto a glossy finish label 26. Further, other embodiments can print any such combination including at least the variable label content onto a label 26 having a finish other than glossy or flat. If only the variable label content is to be printed by the printer 24, the label 26 can optionally include pre-printed fixed label content thereon and the variable label content is printed in designated regions of the label 26 as described in detail below.

Analogous to the feeder 18, the printer 24 in FIG. 2 includes an ink-cartridge carriage 44 that can also travel along a second transverse axis 46. The carriage 44 supports one or more ink cartridges 48a, 48b that dispense fine drops of ink in a predetermined pattern onto the label 26 as controlled by the control unit 28, an arrangement that is commonly referred to as an ink-jet printer. The ink cartridges 48a, 48b can include any combination of colors and inks, but the embodiment shown in FIG. 2 includes a black ink cartridge 48a and a color ink cartridge 48b. Each ink cartridge 48a, 48b can be independently replaced as needed when the supply of ink therein is exhausted. And similar to the automated feeder 18, the printer 24 can be operatively coupled to the communication interface 33 by plugging the printer 24 into a printer port 25 provided to a printer driver card 27 in communication with the communication interface 33, as shown schematically in FIG. 6.

The variable, and optionally the fixed label content can be printed onto the label 26 provided to the portable computer-readable medium 12 while the portable computer-readable medium 12 is seated in a printer tray 50. As shown in FIG. 2, the printer tray 50 is vertically stacked above the recording bays 32. Either before or after the electronic data is recorded onto the portable computer-readable medium 12, the portable computer-readable medium 12 is placed in the printer tray 50 by the automated feeder 18. If the variable, and optionally the fixed label content is printed onto the label 26 after the electronic data is recorded onto the portable computer-readable medium 12, the feeder 18 retrieves the portable computer-readable medium 12 from the recording bay 32 similar to the manner in which the feeder 18 retrieves the portable computer-readable medium 12 from the supply bin 17. Namely, the arm 36 is translated along the transverse axis 38 by the drive motor 34 until the grasping tool 40 is approximately aligned with the aperture 42 formed in the portable computer-readable medium 12 in the support tray of the recording bay 32, which is now extended in the open position. So aligned, the grasping tool 40 is lowered into the aperture 42 and the diameter of the grasping tool 40 is enlarged from its insertion diameter to couple the portable computer-readable medium 12 to the arm 36. The grasping tool 40 is then raised to elevate the portable computer-readable medium 12 out of the support tray of the recording bay 32, at which time the printer tray 50 is extended outwardly to receive the portable computer-readable medium 12. Once the printer tray 50 is properly extended, the grasping tool 40 lowers the portable computer-readable medium 12 to the printer tray 50, from where the diameter of the grasping tool 40 is retracted to its insertion diameter, thereby allowing the portable computer-readable medium 12 to fall onto the printer tray 50. With the portable computer-readable medium 12, the printer tray 50 is retracted inwardly to begin the printing process.

As an ink-jet printer, the carriage 44 only moves along the second transverse axis 46. Thus, the variable, and optionally the fixed label content are printed onto the label 26 with the coordinated lateral movement of the carriage 44 and the inwardly and outwardly movement of the printer tray 50. Coordination of these movements is performed by the control unit 28 to generate the desired patterns on the label 26 in a known manner. Thus, printing of the variable, and optionally the fixed label content is performed in an analogous manner to the printing of any text or graphic onto a sheet of paper with a conventional inkjet printer.

Once publication of the portable computer-readable medium 12, which includes the recording of the electronic data onto the portable computer-readable medium 12 and the printing of any variable and optional fixed label content onto the label 26, is complete, the feeder 18 can retrieve the portable computer-readable medium 12 from the printer tray 50 or recording bay 32 and eject it from the publisher 10. The feeder 18 once again retrieves and transports the portable computer-readable medium 12 from the printer tray in a manner similar to that described above. However, to eject the portable computer-readable medium 12 from the publisher 10, the diameter of the grasping tool 40 is returned to its insertion diameter while the portable computer-readable medium 12 is suspended over an inclined discharge path 52. The portable computer-readable medium 12 slides along the discharge path 52, through an aperture 54 formed in an optional cover 56 provided to the publisher 10, and into a published media receiver 58, from where it can be retrieved by the operator.

To control operation of the publication processes performed by the publisher 10, the operator can enter control commands with a user interface 22. Embodiments of the user interface 22 include a touch-screen display panel that is responsive to the touch of the operator. For such embodiments, soft keys can be displayed on the touch-screen display panel 22 from which the operator can select. Soft keys are computer generated images of keys displayed on the touch-screen display panel 22 that correspond to locations on the touch-screen display panel 22 that can be touched by the operator to enter a command corresponding to that soft key.

As shown in FIGS. 1, 2 and 3, the control unit 28 and the recorder 16 can be vertically stacked to minimize the footprint of the publisher 10, thereby minimizing the surface area of a countertop consumed by the publisher 10. The control unit 28 and the recorder 16 can be self contained, distinct components as shown in FIG. 3, wherein the recorder 16 rests atop of the control unit 28 to form an integral unit. Other embodiments include a recorder 16 and control unit 28 integrally formed as a single, monolithic unit. The electrically-conducting and communication pathways that operatively couple the recorder 16 to the control unit 28 can be established through the use of cables with suitable terminal connectors as is known in the art.

FIG. 3 also illustrates an embodiment of a communication interface 33 that is operatively coupled to the control unit 28 for communicating the electronic data to the publisher 10 to be recorded onto the computer-readable medium 12. As previously mentioned, the electronic data can optionally represent medical images such as digital x-rays, which are the x-ray images captured directly by a film plate exposed to radiation; digitized x-rays, which are images of digital x-rays captured by an optical image capture process; CT scans; magnetic resonance imaging (“MRI”) scans; positron emission tomography (“PET”) scans, and the like. These electronic data are generated by the x-ray machine and the CT scanner, respectively, and must be transmitted to the publisher 10. Accordingly, the communication interface 33 receives the electronic data from the machine generating the electronic data directly, over a local area network, over a wide area network such as the Internet, or any combination thereof. For embodiments where the electronic data are transmitted to the publisher 10 over a network, the electronic data are transmitted according to a communication protocol such as TCP/IP, for example. The communication interface 33 is operable to communicate according to the particular communication protocol at the medical facility where the publisher 10 is installed to communicate with the network. Through this communication, the communication interface 33 can receive the electronic data and communicate the received electronic data to the control unit 28 to be stored at least temporarily in a computer-accessible memory provided to the publisher 10.

For embodiments where the electronic data is communicated over a network, the communication interface 33 is operatively coupled to a communication driver 90 that translates the communication signal into a format that can be parsed by the control unit 28, described below. Examples of suitable communication drivers 90 include a network interface card provided with a plug 61 that into which a cable can be inserted to connect the publisher 10 to a network (e.g., Ethernet network, Bluetooth wireless network, or the like), a modem (e.g., 56K baud, ISDN, DSL, or cable modem), and the like.

A network, as used herein, is merely a group of two or more systems capable of communicating electronic data from one system to another that are linked together by a data communication path. There are many types of such networks, including a local area network (“LAN”), virtual private network (“VPN”), a metropolitan area network (“MAN”), campus area network (“CAN”), and a wide area network (“WAN”) such as the Internet. As used herein, the term “network” refers broadly to any group of two or more computer systems or devices that are linked together either permanently, or temporarily from time to time. Additionally, a network can include a medical imaging instrument such as an x-ray machine, CT scanner, and the like; electronic test equipment such as a nuclear magnetic resonance (“NMR”) spectroscope, and the like; and any other device capable of communicating electronic data over a communication pathway that is in communication with the publisher 10, either directly or from a remote location.

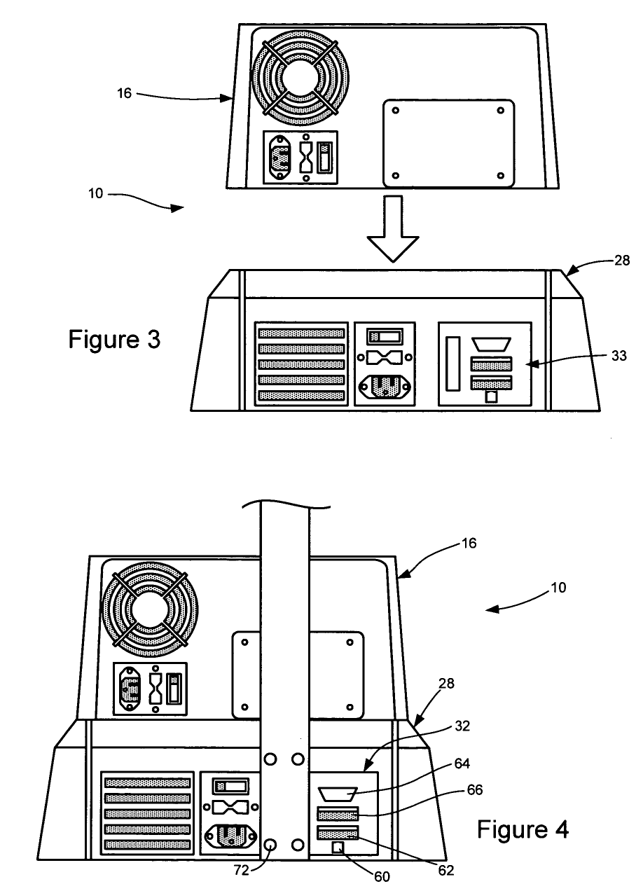

For the embodiments shown in FIGS. 3 and 4, the communication interface 33 includes a plurality of additional optional inputs. For example, the input to the communication interface 33 from the network can be a conventional RJ45 socket 60. Further, conventional universal serial bus (“USB”), USB 2.0, and firewire ports 62 can optionally be provided as auxiliary inputs, as well as any other suitable input. The communication interface 33 can also include a USB port 66 or other suitable ports for communicating with the recorder 16, for example.

All components of the publisher can optionally be vertically stacked, including the touch-screen display panel 22 or other user interface 22 as shown in FIG. 1. For such embodiments, the touch-screen display panel 22 is secured to the publisher 10 with an elongated bracket 70, shown best in FIG. 4, by one or more thumb screws 72 that can be tightened by hand without the use of tools. Again, vertically stacking the publisher 10, including the touch-screen display panel 22, serves to minimize the footprint of the publisher 10, thereby minimizing the surface area of a countertop consumed by the publisher 10. Further, for embodiments with a touch-screen display panel 22 as the user interface, the publisher is fully operational as a unit without any external peripheral user interface devices such as a mouse. The publisher 10 of such embodiments is self contained, meaning that all features necessary for operation of the publisher 10 are integrated together into a single, freestanding unit without external peripherals necessary for the operation of the publisher 10 extending therefrom.

Alternate embodiments include any combination of a recorder 16, control unit 28 and user interface 22 that are vertically stacked in a generally vertical arrangement relative to each other, regardless of whether any or all of them are secured together. Thus, substantially vertical arrangements including any one or more of a control unit 28, recorder 16 and user interface 22 are within the scope of the present invention, even if such components are independently supported upon different shelves, or a stand. Again, the substantially vertical arrangement minimizes the surface area consumed by the publisher 10.

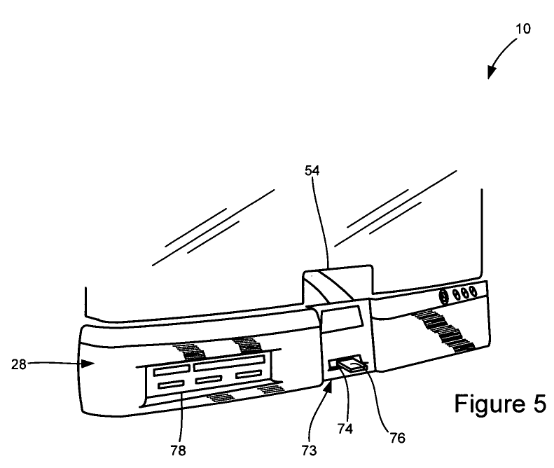

FIG. 5 illustrates an embodiment of the publisher 10 including an optional memory interface 73 for receiving a memory module 76 storing third-party computer-executable instructions that facilitate the review of the electronic data recorded onto the portable computer-readable medium 12 by the end user with a personal computer. In the embodiment shown in FIG. 5, the memory module 76 is a conventional USB flash memory device that is being inserted into a USB memory-module interface 74 provided to the overall memory interface 73. The USB memory-module interface 74 is concealed by the published media receiver 58 when it is installed on the publisher 10, and the published media receiver 58 can be removably secured to the publisher 10 with the memory module 76 installed in the USB memory-module interface 74. The memory interface 73 is operatively connected to the control unit 28, which is programmed to search a predetermined directory of the memory module 76 for computer-executable instructions, commonly referred to as software, supplied by a third party to facilitate the review of the electronic data by the end user.

The search for third-party software can automatically be performed by the control unit 28 during a publication process that is recording electronic data onto the portable computer-readable medium 12 without intervention by the operator. Examples of the third-party software include, but are not limited to, a text-document viewer, an image viewer, a motion video viewer, a visual media viewer, and an audible media player. When a piece of third-party software that can open a file represented by the electronic data to be retrieved by the end user from the portable computer-readable medium 12 is located on the memory module 76, the control unit 28 can automatically cause that piece of third-party software to be recorded onto the portable computer-readable medium 12 along with the electronic data. This recording of the third-party software can be performed automatically without intervention by the operator specifically directed to selecting and recording the third-party software. In this manner, an end user is assured the ability to be able to access files represented by the electronic data recorded on the portable computer-readable medium 12. This is true even if those files require a piece of proprietary third-party software for review that an end user is not otherwise likely to have access to.

Alternate embodiments of the publisher 10 include one or more ports into which any format and type of removable memory module 76 can be removably inserted to provide access to third-party software, in addition to, or in lieu of the USB memory-module interface 74. For example, the memory interface 73 shown in FIG. 5 also includes a set of auxiliary memory module ports 78, that can include any suitable communication port, including, but not limited to a compact flash port, a memory stick port, a serial port, a parallel port, a microdrive port, and a secure digital card port.

One or more of the auxiliary memory module ports 78 can also act as a recording interface 92 (FIG. 2) for establishing a communication path between the publisher 10 and an external recording device (not shown). The electronic data optionally can be recorded onto the external recording device through the recording interface 92 substantially-continuously as the electronic data is communicated to the publisher 10. By substantially-continuously recording the electronic data onto the external recording device, it is meant that the electronic data is recorded onto the external recording device automatically, without operator intervention as the electronic data is received by the publisher 10. The electronic data of each study can be substantially-continuously streamed to the external recording device at about the same time as the electronic data is stored in the RAM 82, computer-accessible memory 88, or both, of the publisher 10. Alternate embodiments automatically record the electronic data onto the external recording device automatically, without operator intervention only once all, or a predetermined portion of the electronic data for each study is fully received by the publisher 10, and recorded in the RAM 82, computer-accessible memory 88, or both. The predetermined portion of the electronic data can be one image out of a plurality of images to be communicated to the publisher 10 as part of a study, for example.

The substantially-continuous recording of the electronic data onto the external recording device minimizes the recording time required following receipt of the last of a plurality of studies to record all of the studies on the external recording device. In other words, instead of receiving all of the studies and storing them in the RAM 82, computer-accessible memory 88, or both, and then recording all those studies in a single batch recording process afterward, the studies are recorded substantially-continuously, and in real time as the electronic data is received by the publisher 10. Thus, the operator does not necessarily have to wait a long period of time for the recording of the electronic data of the plurality of studies onto the external recording device to be completed following communication of the electronic data of the last study to the publisher 10. Instead, the operator can remove the external recording device from the recording interface 92 after a period of time required to record the electronic data of the last study onto the external recording device has elapsed. This waiting period is shorter in duration than the time required to record the electronic data of all of the studies communicated to the publisher 10 onto the external recording device as a batch after the last study has been communicated to the publisher 10.

The control unit 28 according to an embodiment of the present invention is shown schematically in FIG. 6. The control unit 28 includes many of the features commonly included in a conventional personal computer. These components of the control unit 28 operate according to commands contained in computer-executable instructions, or software, stored in a computer-accessible memory 88 operatively coupled via a data bus with the control unit 28. The control unit 28 can be adapted to carry out the method steps described herein that are to be performed in response to execution of the computer-executable instructions.

The recording interface 92 is compatible with one or more of the external memory devices selected from the group consisting of: a universal serial bus flash drive, a portable digital audio player, a cellular telephone, a microdrive, a compact flash card, and a secure digital card. Further, the recording of the electronic data onto the external recording device can be performed independent of the recording of the electronic data onto the portable computer-readable medium. Thus, electronic data forming one or more studies communicated to the publisher 10 and stored in the RAM 82, computer-accessible memory 88, or both, can be selectively recorded onto a portable computer-readable medium 12 as desired by the operator. The operator can initiate the publishing process via the touch-screen display panel 22 or other suitable user interface. However, independently of the publishing process, the electronic data can be substantially-continuously recorded onto the external recording device through the recording interface 92.

For example, any combination of the method steps performed in accordance with the present invention can optionally be implemented by the control unit 28, which includes the conventional or general-purpose computing components commonly included in an IBM-compatible personal computer (“PC”). As such, the control unit 28 includes a central processing unit (“CPU”) 80 operatively coupled to, and in electronic communication with a random-access memory (“RAM”) 82. The RAM 82 is a volatile memory that can temporarily store electronic data and information used by active applications to save time by eliminating the need to repeatedly retrieve said information from a non-volatile memory device such as a hard disk drive. The control unit 28 further includes a read-only memory (“ROM”) 84 for storing read-only files that are not to be manipulated by the operator of the publisher 10. A fixed computer-accessible memory 88, such as a hard disk drive can be written to and read from by the CPU 80, while the communication interface 33 offers the operator connection options for establishing a communication pathway between the control unit 28 and other features of the publisher 10, and optionally, with an external computer to transmit electronic data to the control unit 28. The communication interface 33 also includes a communication (“COMM”) port 64 to which the touch-screen display panel 22 or other user interface can be operatively coupled to the control unit 28 for transmitting display data to said touch-screen display panel 22 or other user interface. Examples of a suitable COMM ports 64 include, but are not limited to, a serial port, USB port, and the like. The COMM port 64 is in electronic communication with a display driver 86, which acts as a graphics card for translating electronic data transmitted from the control unit 28 into a graphical user interface (“GUI”). The GUI is to be communicated to the touch-screen display panel 22 or other user interface coupled to the COMM port 64 to generate visible display screens thereon.

The CPU 80 comprises a processor such as that falling within the Intel Pentium family of microprocessors, although any other suitable processor may be utilized for implementing the CPU 80 of the present invention. The CPU 80 communicates with components that can be written to and read from via a bidirectional system bus (including any necessary input/output (“I/O”) controller circuitry) shown in FIG. 6 as bidirectional arrows. Likewise, the CPU can read data from a read-only memory such as the ROM via a unidirectional data bus (including any necessary I/O controller circuitry), indicated in FIG. 6 as a unidirectional arrow. The buses provide data transfer between and among the various components of the control unit 28.

The RAM 82 serves as the working memory for the CPU 80, temporarily storing data during operation of the control unit 28. Embodiments of the present invention include 64 Mbytes of RAM space or more, but alternate embodiments of the control unit 28 include more or less RAM space, as appropriate. In contrast, the ROM 84 stores the basic input/output system code (“BIOS”), which includes a set of low-level routines that application programs and the operating systems can use to interact with the hardware, including reading characters input via the touch-screen display panel 22 or other user interface, outputting text and graphical data to be printed by the printer 24, and so forth.

The computer-accessible memory 88 provides persistent, nonvolatile storage of electronic data on fixed and removable media, such as a magnetic, optical or magnetic-optical storage system, any other available mass storage technology, or any combination thereof. The computer-accessible memory 88 may be shared on a network, or it may be a dedicated memory device. For the embodiment shown in FIG. 6, the computer-accessible memory 88 stores a body of computer-executable instructions commonly referred to as software, such as an operating system for directing operation of the control unit 28, end user application programs, drivers and other support files, as well as other data files of all sorts. The computer-accessible memory 88 can be employed as the main hard disk drive for the publisher 10.

In basic operation, computer-executable instructions (including that which implements methodology of the present invention described below), also referred to herein as program logic or software, is loaded from the computer-accessible memory 88 or ROM 84 into the RAM 82 for execution by the CPU 80. The program logic is executed by the CPU 80, resulting in implementation of the method steps of the present invention. During execution of the program logic, the publisher 10 accepts control commands input by the operator via the touch-screen display panel 22 or other user interface. The touch-screen display panel 22 or other user interface permits selection of application programs, entry of keyboard-type input or data, and selection and manipulation of individual data objects displayed on the touch screen 22 or other display device.

The control unit 28 causes to be displayed text and/or graphical images by the touch-screen display panel 22 or other user interface. The display driver 86, which is interposed within the communication path between the touch-screen display panel 22 or other user interface and the rest of the control unit 28, drives the touch-screen display panel 22 or other user interface. The display driver 86, which includes video memory accessible to the CPU 80, provides circuitry that converts pixel data stored in the video memory to a suitable display signal for generating text and graphical images by the touch-screen display panel 22 or other user interface.

Although the present invention includes embodiments wherein the hardware is vertically stacked, and can optionally be formed as a single, monolithic unit, an external image printer 94 (FIG. 6) can optionally be provided as a peripheral to the publisher 10. The external printer 94 can generate hardcopies of the medical images or other medical documents represented by the electronic data to be recorded onto the portable computer-readable medium 12. An example of a suitable external printer 94 is offered for sale under the trade name Horizon®, by Codonics, Inc., of Middleburgh Heights, Ohio. Such an external printer can generate hardcopies of the medical images or other documents represented by the electronic data as a dry film imager for x-ray images, a color imager, and grayscale paper imager. Further, this external printer 94 can automatically switch between film, color and paper without operator intervention.

Hardcopies of all the medical images or other documents in a study can be produced automatically, without operator intervention as the study is selected to be recorded onto the portable computer-readable medium 12. Alternate embodiments display printing options available to the operator on the touch-screen panel 22 from which the operator can select one or more medical images or other documents out of a plurality of said images and documents to be printed by the external printer 94. Further, to ensure an accurate representation of the medical images and other medical documents to be printed by the external printer 94, the images may be mapped. Mapping of the image establishes grayscale levels of a hardcopy image to be printed by the external image printer 94. For example, the images can be mapped by identifying the upper and lower grayscale levels found in the image to be mapped. If these grayscale level limits are suitable for printing the hardcopy with the external image printer 94, the hardcopy can be printed with the external image printer 94 as is. The grayscale increments between the grayscale level limits can also be specified depending on the desired resolution of the hardcopy of the image to be printed.

However, it is often desirable to print an image with grayscale level limits other than those of the image in its native resolution. For such embodiments, the native image can be mapped by identifying the grayscale level limits, and then adjusting the lower and upper grayscale limits (i.e., the grayscale values that correspond to black and white) to another grayscale level. For example, it is often desirable to print pure white features in an image in off-white or even gray. Then, the white features are mapped to correspond to the desired off-white or gray grayscale level, and the other grayscale increments scaled accordingly. Image mapping can be performed by the control unit 28 automatically, without intervention by the operator, or based on manually-input by the operator via the touch-screen display panel 22. Yet alternate embodiments can map the image based at least in part on the substrate onto which the hardcopies are to be printed via the external printer 94. The external image printer 94 can include a plurality of different printing profiles that govern the image mapping, if any to be performed by the control unit 28.

In use, the control unit 28 and the other features of the publisher 10 can execute the computer-executable instructions of the present invention to implement the method steps to be performed for publishing a portable computer-readable medium 12 described in detail below.

FIG. 7 illustrates a general publication method of publishing a portable computer-readable medium 12 performed by execution of computer-executable instructions provided to the computer-accessible memory 88 in accordance with an embodiment of the present invention. As shown, the method generally includes receiving the electronic data representing one or more medical images or other medically related documents that make up a study, recording the electronic data onto the portable computer-readable medium 12, printing at least the variable label content, and suitably transporting the portable computer-readable medium 12.

Each study can correspond to an examination of a patient during a given visit or series of visits, a series of tests performed in the diagnosis or treatment of a medical condition, or any other single medical subject matter. Electronic data making up more than one study can be recorded onto a given portable computer-readable medium 12. And as previously mentioned, the electronic data can represent one or more medical images such as an x-ray and CT scan, or other type of medical document such as a chart, patient record and the like.

At step 101 of the general method illustrated in FIG. 7, the electronic data making up the medical study to be recorded onto the portable computer-readable medium 12 is received by the publisher 10, and stored in the RAM 82, computer-accessible memory 88, or a combination thereof. The electronic data can be received over a network or directly from a medical instrument through the communication interface 33 of the publisher 10. Further, each study to be recorded onto the portable computer-readable medium 12 can be streamed to the publisher 10 while it is being recorded onto the portable computer-readable medium 12, or it can be recorded in batches, such as study by study once a portion or all of the study is received by the publisher 10.

Some embodiments of the present invention can conclude that all electronic data forming a given study has been received upon the occurrence of a lengthy timeout period. The timeout is simply a period of inactivity that lasts for a predetermined period of time, such as 30 seconds, when no electronic data for the study is transferred. This is not to say that no electronic data is communicated to the publisher 10 at all. Electronic data can be transmitted to the publisher 10 for a different study without affecting the timeout period for the study of interest.

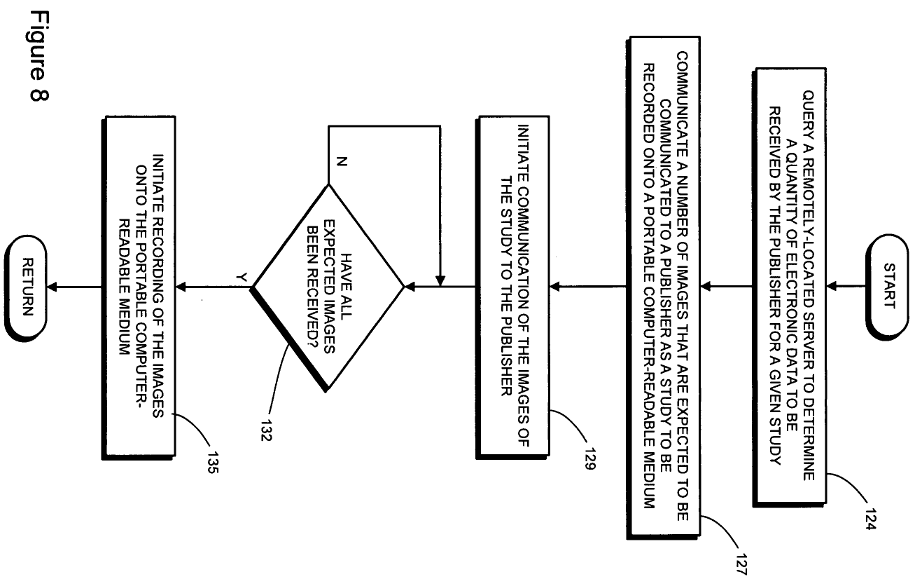

Alternate embodiments of a method of receiving the electronic data that eliminates the need for a lengthy timeout period to indicate that all electronic data for a complete study has been received is shown graphically in FIG. 8. According to the embodiment shown in FIG. 8, a query of a remotely located server is performed at step 124 to determine a quantity of electronic data that can be expected for each study retrieved from the remotely-located server. The quantity of electronic data can be a number of medical documents and images such as x-rays, CT scans, and the like to be retrieved from the remotely located server and recorded onto the portable computer-readable medium 12. For such embodiments, the communication of medical images can be compliant with the DICOM standard, which is the Digital Imaging and Communication in Medicine standard. A DICOM query queries a Picture Archive & Communication System (“PACS”), which is commonly a central electronic archive for all images in many radiology departments and other imaging centers. The DICOM query results in the determination of the number of images that will make up a study to be recorded onto the portable computer-readable medium 12 by the publisher 10. The total number of images to be expected by the publisher 10 can be transmitted in response to the query at step 127, optionally along with the first image of the study as communication of the expected number of images commences at step 129. Once all of the expected images determined by the query have been received by the publisher 10 as determined at step 132, recording of the electronic data onto the portable computer-readable medium 12 is initiated step 135. For such embodiments, the lengthy timeout period typically relied upon to indicate the receipt of all images by the publisher 10 can be eliminated, or at least minimized.

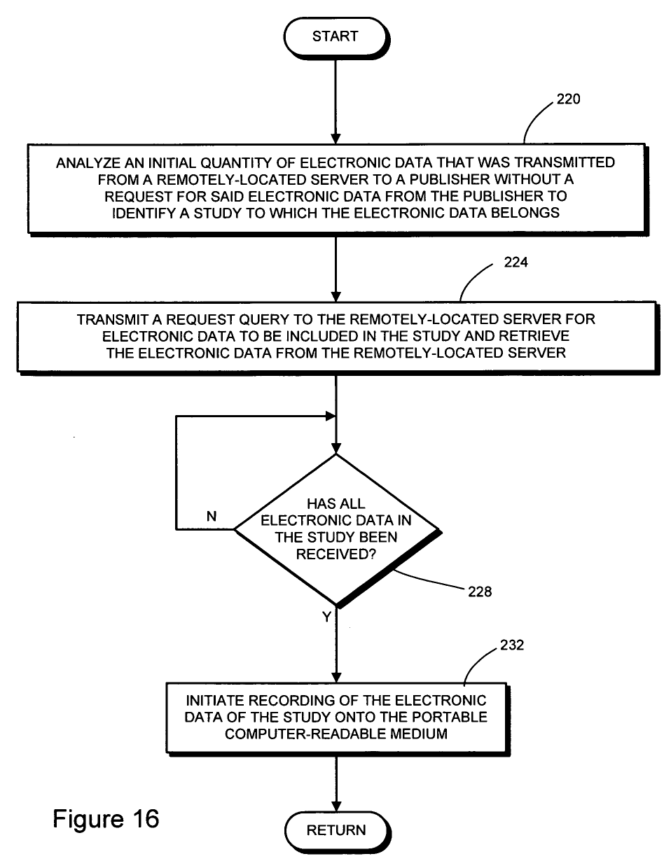

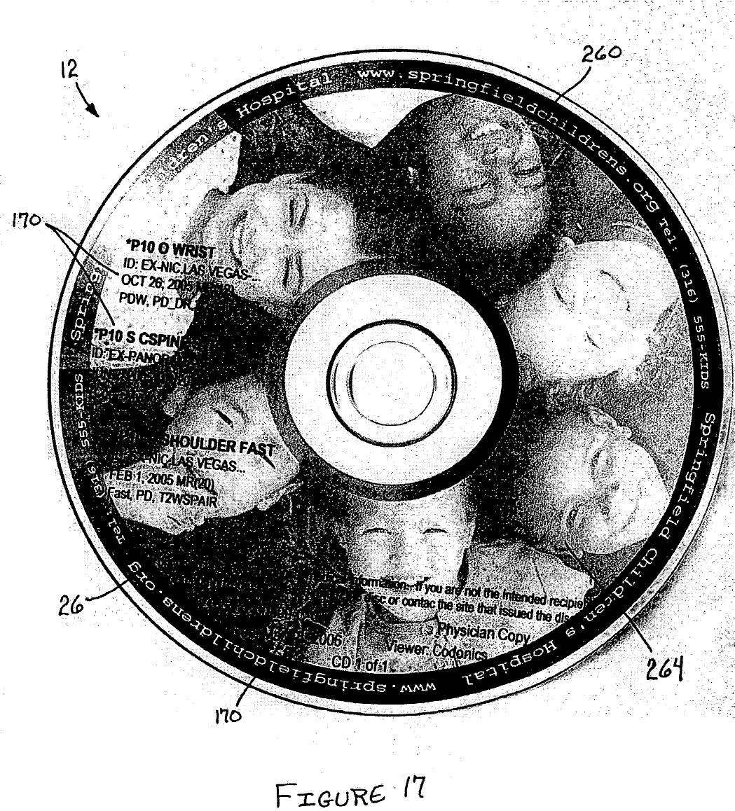

Yet other alternate embodiments of the present invention submit a request to the remotely-located server to “pull” at least a portion of a study to the publisher 10 from the remotely-located server. An example of such an embodiment is shown schematically in FIG. 16. FIG. 16 is a flow diagram illustrating an exemplary method of receiving electronic data from a remotely-located server to be recorded onto a portable computer-readable medium 12. Consider once again communication between the publisher 10 and the remotely-located server according to the DICOM standard. Electronic data in a medical study, upon be communicated to the remotely-located server, can optionally be automatically transmitted to the publisher 10 from the remotely-located server without a request from the publisher 10 for said electronic data. Such electronic data is said to be “pushed” from the server side since it is being transmitted without first receiving a request from the publisher 10 that is to receive it. Pushing electronic data from a DICOM server is a low priority, resulting in long communication times required to complete communication of all electronic data to the publisher 10 for a given study.

However, the initial quantity of electronic data pushed from the remotely-located server according to the DICOM standard includes descriptive information that identifies the study to which the automatically-transmitted electronic data belongs. This initial quantity of electronic data received by the publisher 10 is analyzed at step 220 to identify the study to which the electronic data belongs. Once the study has been identified by the control unit 28, a request query can be submitted to the remotely-located server by the control unit 28 of the publisher 10 or other controller at step 224. The request query requests from the remotely-located server the electronic data to be included in the identified study. Such electronic data requested by the publisher is referred to as being “pulled” from the remotely-located server. The request query elevates the data rate at which electronic data is transmitted from the remotely-located server, such as a DICOM server, to a rate that is greater than that for transmitting the pushed electronic data from the remotely-located server. Accordingly, the higher data rate for transmitting pulled electronic data from the remotely-located server relative to the data rate at which electronic data is pushed from the remotely-located server makes communication of such pulled electronic data faster than the communication of pushed electronic data. When it is determined at step 228 that all, or a sufficient portion of the pulled electronic data has been received for the identified study, the method can initiate recording of the electronic data of the identified study onto the portable computer-readable medium 12 at step 232, either automatically or as instructed by the operator. Before the recording is initiated at step 232, however, it is determined whether the portable computer-readable medium 12 is disposed within the recording bay 32, and if not, the method initiates the supply of said portable computer-readable medium 12 to the recording bay 32 before recording is initiated.

The electronic data pulled from the remotely-located server can be completely received, or at least sufficiently received to initiate recording of the electronic data, before the electronic data being pushed from the remotely-located server to the publisher. To minimize the amount of duplicate electronic data that is at least temporarily retained by the publisher 10, the publisher can receive and then discard the electronic data being pushed from the remotely-located server without recording the pushed electronic data, receive and delete the pushed electronic data, delete the pushed electronic data, ignore the pushed electronic data altogether, or otherwise suitably handle the pushed electronic data.

Referring once again to FIG. 7, the portable computer-readable medium 12 onto which the electronic data is to be recorded is supplied to the recording bay 32 of the recorder 16 automatically, without physical intervention by the operator at step 105. That is, once the publisher 10 is activated by the operator, the arm 36 of the automated feeder 18 is positioned by the drive motor 34 to hover the medium grasping tool 40 along the central axis 41 of the portable computer-readable medium 12 to be supplied to the recording bay 32. Positioning of the arm 36 is performed according to a control protocol, which can be defined by computer-executable instructions stored in the computer-accessible memory 88 of the control unit 28. The medium grasping tool 40 described above is lowered into the aperture 42 and expanded to releasably couple the portable computer-readable medium 12 to the arm 36. The medium grasping tool 40, and the portable computer-readable medium 12 coupled to it, is raised to extract the portable computer-readable medium 12 from the supply bin 17. The arm 36 is again repositioned by the drive motor 34 to suspend the portable computer-readable medium 12 over a supporting tray, which is extended out of the recording bay 32 as the arm 36 approaches. With the medium grasping tool 40, and accordingly, the portable computer-readable medium 12 positioned above the outwardly extended supporting tray of the recording bay 32, the medium grasping tool 40 is retracted to release the portable computer-readable medium 12 therefrom. The portable computer-readable medium 12 falls onto the supporting tray, which is then retracted into the recording bay 32 from where the electronic data can be recorded by an optical signal in a known manner onto the portable computer-readable medium 12.

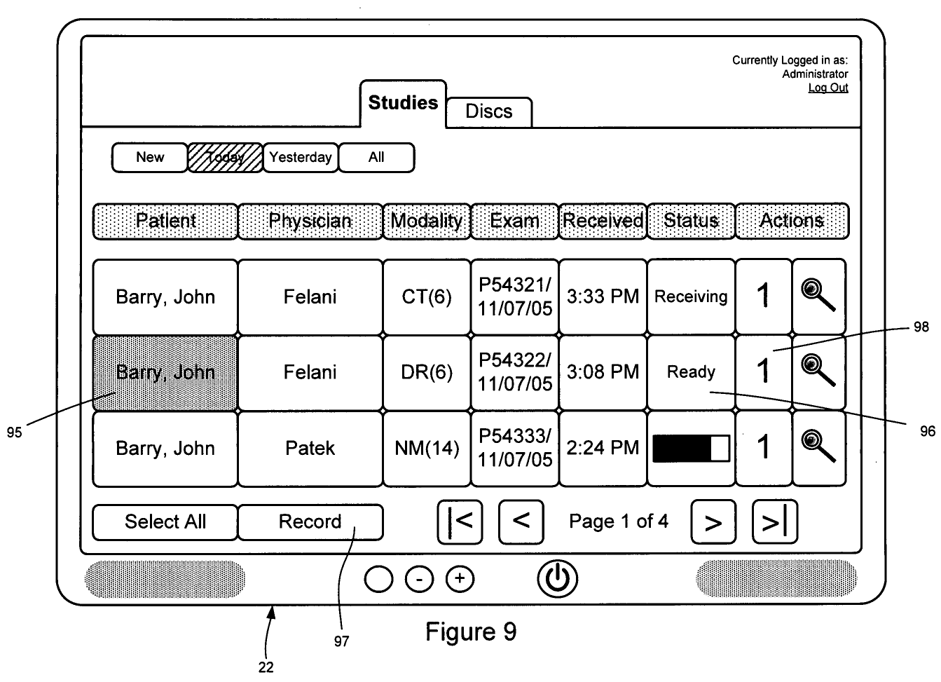

Recording of the electronic data onto the portable computer-readable medium 12 within the recording bay 32 can be initiated at step 109 automatically by the control unit 28, without intervention by the operator once the publishing process has been initiated. To initiate the publishing process, the operator can create a job profile by selecting one or more studies received by the publisher 10 to be recorded onto the portable computer-readable medium 12 by touching the patient field 95, or any other field within the same horizontal study row, as shown in FIG. 9, for example. The selected study is indicated by the highlighted patient field 95 in the display screen. The operator can also select, as part of the job profile, one or more third-party software applications to include on the computer-readable medium 12, as described in detail below, along with the electronic data to facilitate the end user's review of the electronic data with a personal computer. Thus, the job profile includes the electronic data, any third-party software to be recorded onto the portable computer-readable medium, and any selected promotional material described below to be recorded onto the portable computer-readable medium 12, along with other parameters specified by the operator regarding the label and otherwise governing the publishing process. Alternate embodiments include a job profile that also references a site profile that includes site-specific information related to a medical facility responsible for generating the electronic data, publishing the portable computer-readable medium 12, or both. By referencing a site profile automatically, the job profile can automatically determine the fixed label content to be printed onto the label 26. Thus, for embodiments of the present invention wherein the publisher is enclosed within a mobile housing to be relocated to different medical facilities, referencing the proper site profile ensures the appropriate fixed label content is provided to the label 26 for each end user. Once the operator indicates that the job profile is complete, recording of the one or more studies in the job profile and any other selected electronic data and software can be initiated by the operator's selection of a “Record” soft key 97.

The status has been indicated as “Ready” by the shading shown in the status field 96, meaning that the electronic data for the selected study can be recorded onto the portable computer-readable medium 12. A plurality of studies can be selected by touching the patient field 95 of each desired study, and pressing the “Record” soft key 97 manually initiates the publishing process of recording each selected study onto a common portable computer-readable medium 12 as a single job, or optionally, onto separate portable computer-readable media 12 as different jobs. Publishing of the selected study in FIG. 9 can also be manually initiated by selecting the “Record” soft key 97 displayed by the touch-screen display panel 22. Alternate embodiments include a “one-touch” quick record soft key 98, which, upon selection of that soft key 98, immediately initiates the publishing process for the study associated with that respective one-touch soft key 98. The user interface 22 can display the quick record option for any study including one or more images. When selected, the quick record soft key 98 initiates the publishing process for that study, including recording all images within the study onto a portable computer-readable medium 12 without further intervention by the operator. Yet other embodiments include automatic publishing that commences as the electronic data is received by the publisher 10, without intervention by the operator.

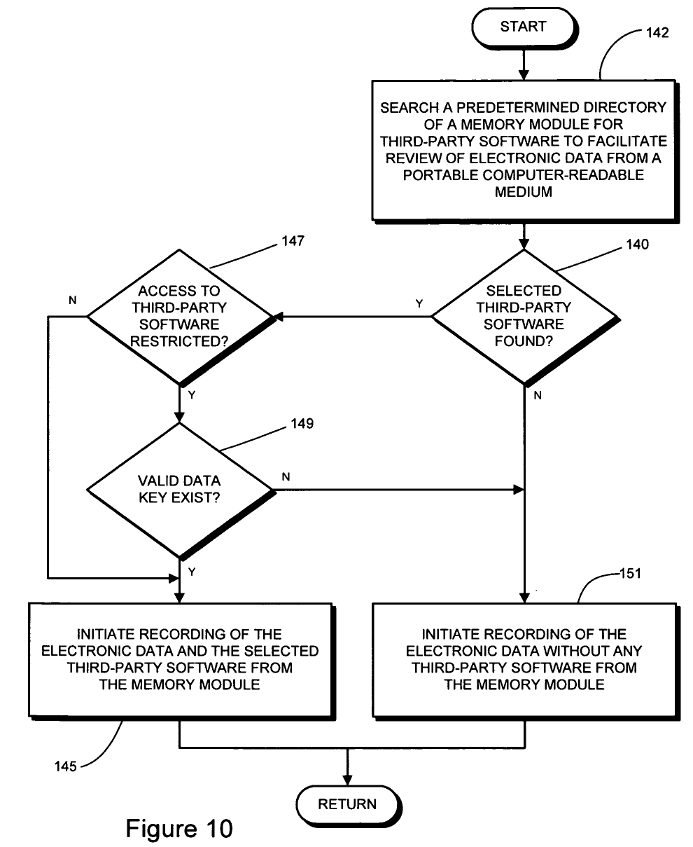

The recording step 109 can also optionally include method steps for searching a memory module 76 for, and recording any available third-party software onto the portable computer-readable medium 12 from the memory module 76 operatively coupled to the publisher by the memory interface 73. Steps for such an embodiment are shown graphically in FIG. 10. A search for any third-party software selected by the operator to be included in the job profile that could facilitate review of all, or at least a portion of the electronic data is conducted at step 142 to determine whether the selected third-party software is available on the memory module 76. By searching a predetermined directory of the memory module 76 that can be removably coupled to the publisher 10, any offering of third-party software can readily be updated merely by providing a replacement memory module 76 with the desired third-party software or updating the existing memory module 76. No alterations of the publisher 10 are required to perform such an update to the offering of third-party software other than to replace the existing memory module 76 with the replacement memory module 76. If the operator has made such a selection as determined at step 140, then the method continues to determine if access to the selected third-party software on the particular memory module 76 in use is restricted by an electronic lock, an encryption technique, a data key, or other software protection scheme at step 147. A data key, for example, can be required to selectively unlock any third-party software stored by the memory module 76. For the embodiments where the memory module 76 is a USB flash drive, each such drive is provided with an identification number that distinguishes it from other USB flash drives, even those falling within the same model line. A unique data key, which is a sequence of characters that are unique to each memory module 76, can be required to be entered before the third-party software is able to be recorded onto the portable computer-readable medium 12 from the memory module 76. If no such protection scheme is detected at step 147, then the third-party software can be recorded onto the portable computer-readable medium 12 at step 145, optionally along with the electronic data.

If, on the other hand, it is determined at step 147 that access to the third-party software is restricted by a protection scheme, then it must be determined if a valid data key or other unlocking method has been entered to grant the operator or party in possession of the memory module 76 access to the third-party software at step 149. If not, then the method reverts to recording the electronic data onto the portable computer-readable medium 12 at step 151 without any third-party software for facilitating review of the electronic data from the memory module 76. If the decision at step 149 is in the affirmative, then the third-party software can be recorded onto the portable computer-readable medium 12 at step 145, optionally along with the electronic data. However, the method bypasses the decisions regarding restricted access to the third-party software it is determined at step 140 that the operator has not selected any third-party software to include on the portable computer-readable medium 12 at step 140. Again, in such circumstances, the recording of the electronic data onto the portable computer-readable medium 12 can be initiated by the control unit 28 without the third-party software at step 151.

Once the recording step of the embodiment of the method shown schematically in FIG. 7 is complete, the method progresses to the transportation of the portable computer-readable medium 12 to the printer 24 at step 115 without operator intervention. Again, what is meant by “without intervention by the operator” is that once the publishing process in FIG. 7 has begun, no further intervention by the operator is necessary to produce the portable computer-readable medium 12 storing the electronic data. Thus, it is not necessary to manually transport the portable computer-readable medium 12 from one station to the next. In a manner analogous to that in which the portable computer-readable medium 12 was supplied to the recorder 16 from the supply bin 17, the arm 36 is again positioned to align the medium grasping tool 40 with the aperture 42 while the portable computer-readable medium 12 is in the extended supporting tray of the recording bay 32. The medium grasping tool 40 couples the portable computer-readable medium 12 to the arm 36, which is again relocated by the drive motor 34 to place the portable computer-readable medium 12 into the printer tray 50.

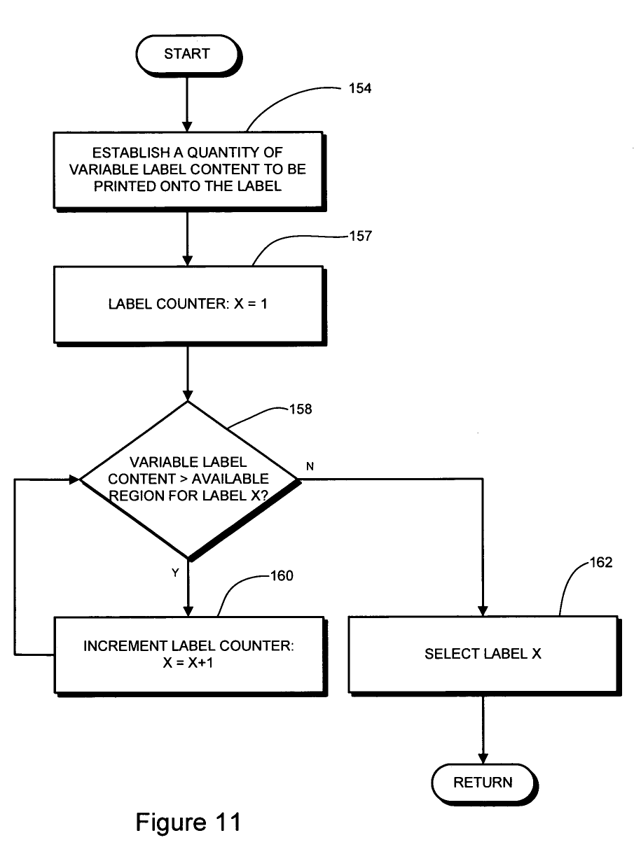

With the portable computer-readable medium 12 in the printer tray 50, at least the variable label content is printed onto a surface of a label provided to the portable computer-readable medium 12 at step 119. The printing step 119 can optionally include an automatic selection of fixed label content depending on at least a quantity of variable label content to be printed onto the label 26 as shown in FIG. 11. When publishing a portable computer-readable medium 12 with the publisher 10, the operator can select a desired fixed label content, and specify the variable label content to appear on the label 26. As previously mentioned, the label 26 can be a non-recording surface of the CD or DVD that is an optical portable computer-readable medium 12, or it can be a label provided to said surface of the optical portable computer-readable medium 12.

At step 154, the quantity of variable label content entered, selected or otherwise indicated as being desired by the operator for inclusion on the label 26 is determined. For some embodiments, the requisite surface area of the label 26 required for this determined amount of variable label content is automatically determined, and for other embodiments, the operator can manually enter the number of entries forming the variable label content that will appear. Alternate embodiments of the present invention can include a library of available fixed label content that is to appear on the label 26 for each number of variable label content entries. For example, there may be a plurality of fixed label content options from which the operator can choose to accommodate four variable label content entries.

Other embodiments simply start at the beginning of the entire library of available fixed label content options at step 157. The actual amount of surface area required for the variable label content specified by the operator is then compared to each fixed label content entry in the library at step 158, said library being arranged in an order of decreasing surface area devoted to fixed label content. If the surface area of the label 26 required for the variable label content is determined to be greater than the available surface area not dedicated for fixed label content at step 158, then the comparison moves on to the next label at step 160. At step 160, a label counter is incremented to allow for a comparison of the surface area for the variable label content to the available surface area not consumed by fixed label content on the next label layout in the library. The method repeats the comparison and incrementing of the label counter until the surface area required for the variable label content is determined to be available in view of the surface area required by the fixed label content. When the surface area for the variable label content is determined to be less than the available surface area of the label not dedicated for the fixed label content at step 158, then the current label layout is selected at step 162. Since the surface area dedicated to the fixed label content decreases each time the label counter is incremented at step 160, the present method maximizes the surface area required by the marketing material or other fixed label content for the variable label content to be printed onto any particular label 26.

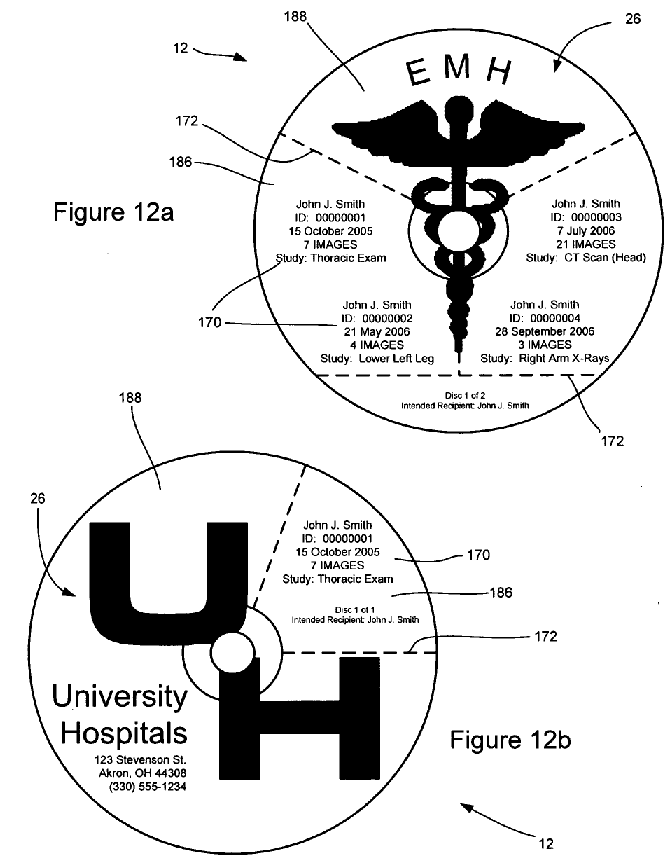

The portable computer-readable medium 12 shown in FIGS. 12a and 12b are illustrative of maximizing the amount of fixed label content in view of the variable label content. There are four studies recorded onto the portable computer-readable medium 12, as indicated by the four passages 170 of variable label content in FIG. 12a. The surface area required for the fixed label content in FIG. 12a is separated from the surface area allocated for variable label content by broken lines 172, although those lines are not required to be visible. The variable label content in FIG. 12a includes information specific to the patient, and four visits by that patient during which images were taken of the patient. In contrast, the fixed label content in FIG. 12a includes a silhouette of the medical insignia Cadusis, along with the initials “EMH” of the medical facility at which the images of the patient were taken, for example.

There is only a single study recorded onto the portable computer-readable medium 12 shown in FIG. 12b, as indicated by the single passage 170 of variable label. The surface area required for the fixed label content in FIG. 12b is again separated from the surface area allocated for variable label content by broken lines 172, although those lines are not required to be visible either. The surface area required to print the variable label content in FIG. 12b is less than the surface area required to print the four passages 170 of variable label content in FIG. 12a. As such, the fixed label content provided to the label 26 in FIG. 12b can consume more of the label's surface area than the fixed label content in FIG. 12a. This allows for more marketing and other suitable fixed label content defined above to be provided to the label 26 without encroaching onto the variable label content. In FIG. 12b, the variable label content includes a single passage of information specific to the patient and the sole study recorded on the respective portable computer-readable medium 12.

Alternate embodiments of the present invention can optionally print the variable label content onto an external label for a portable computer-readable medium 12 that is to be distributed to an end user not affiliated with the medical facility that generated the electronic data. Likewise, a less-expensive and less time-consuming label 26 can be provided to a portable computer-readable medium 12 that is to be distributed to an intended recipient that is affiliated with the medical facility, such as a treating physician who wishes to review the electronic data at another facility. Thus, the time and expense of publishing a portable computer-readable medium 12 can be minimized for those who are affiliated with the medical facility can be minimized. However, printing variable label content onto a label 26 that also includes marketing material and other fixed label content can still be performed for end users who are to receive the portable computer-readable medium 12 and are not affiliated with the medical facility.

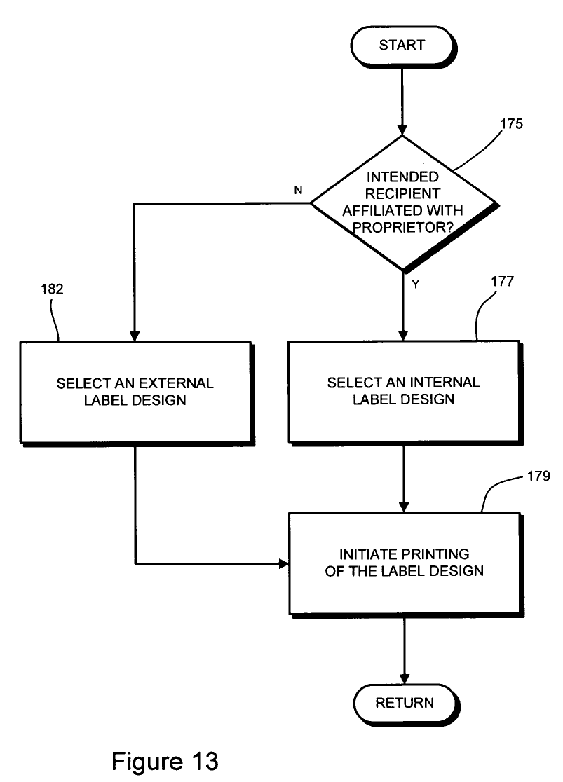

In FIG. 13, a method of printing a label for a portable computer-readable medium 12 is graphically illustrated. At step 175, it is determined who the intended recipient of the portable computer-readable medium 12 is. The intended recipient can be specified by the operator when creating the job profile as being a person or entity affiliated with the medical facility or as not being affiliated with the medical facility. Other embodiments can determine whether the intended recipient of the portable computer-readable medium 12 is affiliated with the medical facility by comparing the name of the intended recipient entered by the operator to a database of people and entities affiliated with the medical facility and to a database of people and entities not affiliated with the medical facility. When a match is made with an entry in either database, then the status of the end user is specified by the control unit 28 as corresponding to the database in which the matching entry is located.

Those affiliated with the medical facility can include any person to whom marketing efforts are not typically made, such as employee physicians, nurses and staff; insurance companies that are to store the portable computer-readable medium 12 for record keeping; attorneys handling a legal issue concerning the electronic data on the portable computer-readable medium 12; and the like. In contrast, those determined not to be affiliated with the medical facility at step 175 can include patients, educational facilities, medical journals, visiting physicians and physician candidates, and the like. Those not affiliated with the medical facility are considered to be a target audience for marketing material disseminated on behalf of the medical facility.

If it is determined that the intended recipient is not affiliated with the medical facility at step 175, then an “internal label design” to be provided to a portable computer-readable medium 12, or a portable computer-readable medium 12 bearing an internal label design is selected at step 177 to be turned over to that intended recipient. An internal label design is less expensive than an external label design and is to be provided to portable computer-readable media 12 given to an end user affiliated with the medical facility. The external label design is to be provided to portable computer-readable media 12 distributed to those not affiliated with the medical facility. Further, the internal label design can optionally be less time consuming to print than an external label design. For example, the internal label design can optionally include only text forming the variable label content for identification purposes, said text being printed in black or another single-color ink, although a plurality of different color inks are also within the scope of the present invention. Similarly, the internal label design can optionally include a flat finish that appears non-glossy. Such labels are less expensive than the glossy finish that can be provided to external label designs. With the internal label design selected at step 177, the control unit 28 can initiate printing of the label at step 179 according to the internal label design. Examples include, but are not limited to, a single color ink, an ink that is less expensive than the ink used to print an “external label,” the least expensive ink available to the printer 24, or any combination thereof.

If, at step 175 the intended recipient or end user is determined to be a patient or other end user not affiliated with the medical facility, then an “external label design” or a portable computer-readable medium 12 bearing an external label design is selected at step 182. In contrast and relative to the internal label design, the external label design is more expensive, and more time consuming to print. The external label design optionally includes a high-gloss finish that reflects light to create a shine that can be observed by the end user. Additionally, the external label design optionally includes one or more graphics not included in an internal label design. Further, the variable label content, and optionally fixed label content, can optionally be printed in a plurality of different colors, and can be used to print color graphics and text. Again, with the external label design selected at step 182, the printing of the label is initiated at step 179 by the control unit 28.

As previously mentioned, the printer 24 can print at least the variable label content onto the label, or onto the non-data surface of the optical portable computer-readable medium 12. Alternate embodiments of the publisher 10 print the variable label content onto pre-printed labels 26 including fixed label content printed earlier in time than variable label content, pre-printed labels already including the desired fixed label content that are provided to the portable computer-readable medium 12, and the like. The portable computer-readable media 12 with the pre-printed label 26 can be stored in one supply bin 17 while the portable computer-readable media 12 with a flat-finish, blank label 26 are stored in the other supply bin 17. The publisher 10 can select the appropriate portable computer-readable medium 12 from the proper supply bin 17 based at least in part on the intended recipient of the portable computer-readable medium 12. If the intended recipient is not affiliated with the medical facility responsible for generating the electronic data of the study to be recorded, the portable computer-readable medium 12 with the pre-printed label can be chosen to store the electronic data. On the other hand, the portable computer-readable medium 12 with a blank label 26 or a minimal graphical label 26 including a basic graphic that can optionally be monochromatic can be chosen if the intended recipient is affiliated with the medical facility responsible for generating the electronic data to be recorded.

The embodiments of the present invention that print variable label content onto a pre-printed label of a portable computer-readable medium 12 may require a desired orientation, position or both orientation and position of the variable label content relative to the fixed variable content. For example, consider a scenario where the decorative fixed label content shown in FIG. 12a (the Cadusis insignia and initials of the medical facility) was pre-printed on the label 26 provided to the portable computer-readable medium 12 before the variable label content was printed on the label 26. It is desirable to print the passages 170 of variable label content on the available surface area 186 allotted for the variable label content instead of the fixed label content surface area 188. Similarly, the single passage 170 of variable label content in FIG. 12b is to be printed on the available surface area 186 allotted for such information, instead of the fixed label content surface area 188 on which the fixed label content is pre-printed.

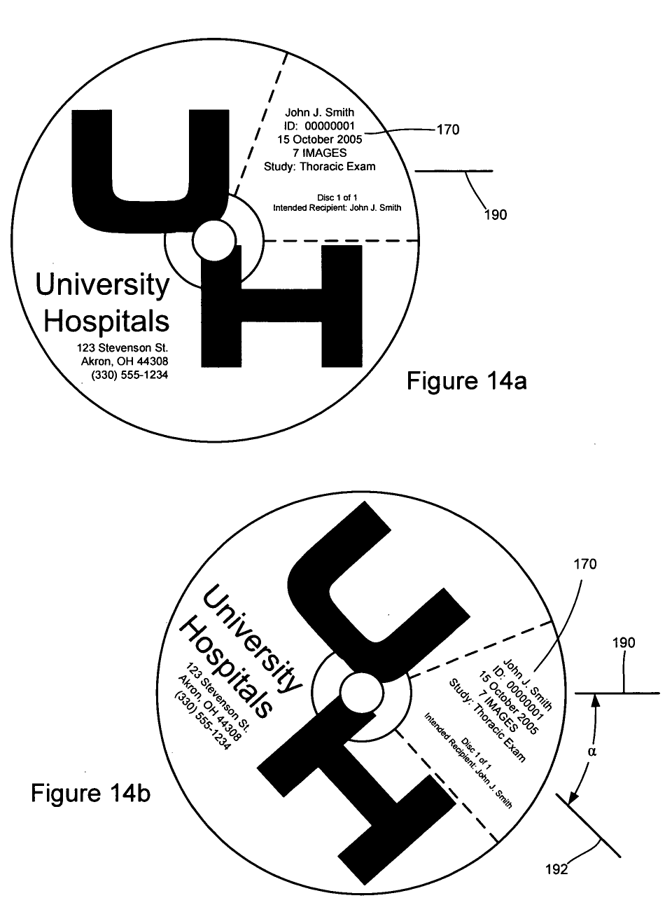

FIGS. 14a and 14b graphically illustrate what is meant by establishing a desired orientation and position of the variable label content relative to the pre-printed fixed variable content that was printed onto the label 26 before the variable label content. FIG. 14 is a top view looking down onto a fully printed label 26 provided to an optical portable computer-readable medium 12. For such an orientation, the passage 170 of variable label content is printed generally parallel with a horizontal line 190, with each character being right side up. However, the optical portable computer-readable medium 12 is rotated around the central axis 41 (FIG. 2) as the electronic data is recorded onto said portable computer-readable medium 12. When the recording is complete, and when the portable computer-readable medium 12 is placed in the printer tray 50, the angular orientation of the portable computer-readable medium 12 about the central axis 41 is unknown. If the portable computer-readable medium 12 is placed in the printer tray 50 with the orientation shown in FIG. 14b, the passage 170 of variable label content must be printed with the angled orientation along line 192 shown in FIG. 14b to have the same orientation and position relative to the fixed label content as the single passage 170 in FIG. 14a had. Generally, the horizontal line 190 along which the single passage 170 was printed in FIG. 14a is now angled at an angle α relative to the horizontal.

Embodiments of the present invention include a device and method for establishing the proper positioning and orientation of the variable label content to be printed onto a label 26 provided to an optical portable computer-readable medium 12. The fixed label content is pre-printed onto the label 26 before the printing of the variable label content. As with the other method steps set forth herein, the method is performed by the publisher 10 as it executes the computer-executable instructions stored in the computer-accessible memory 88 of the control unit 28.

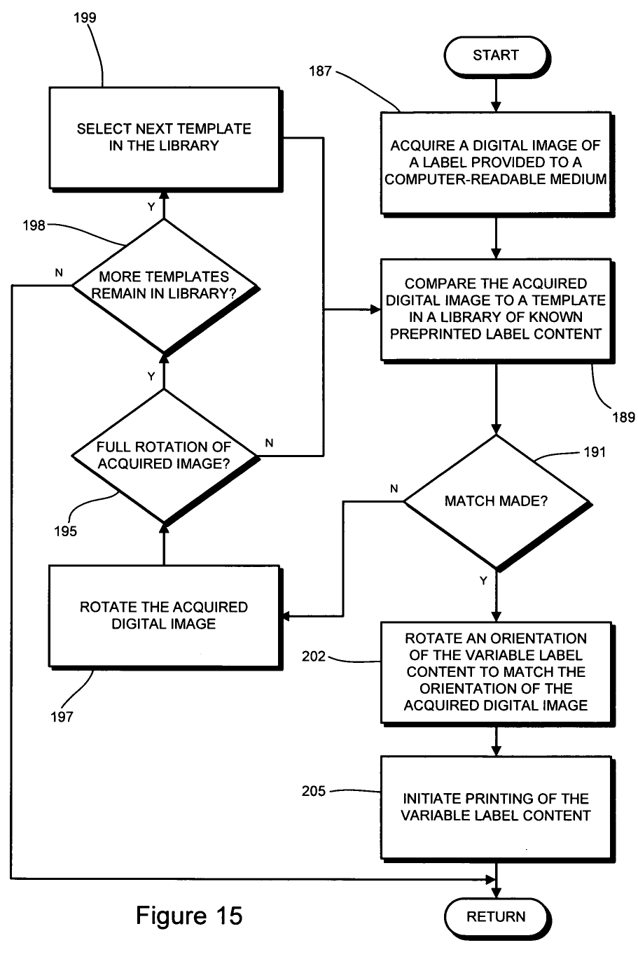

FIG. 15 shows an illustrative arrangement of method steps according to an embodiment of the present invention for establishing the desired position and orientation of variable label content relative to pre-printed fixed label content. An orientation of the portable computer-readable medium 12 introduced to the printer is evaluated at step 187 to identify a location of fixed label content preprinted on the surface of the portable computer-readable medium 12. The evaluation can include capturing a digital image or photograph looking down on the portable computer-readable medium 12, similar to the view onto the portable computer-readable medium 12 shown in FIGS. 14a and 14b. At step 189, the captured digital image is compared to a template of the fixed label content stored in an electronic library in the computer-accessible memory 88, ROM 84, or other electronic storage device.

Whether the captured image matches the template within a predetermined allowable tolerance is determined at step 191. However, since the comparison at step 191 may yield a false negative due to the misaligned relative orientations of the template and the captured image, a negative result does not eliminate that template. Instead, the captured image is incrementally rotated within the memory of the control unit 28 at step 197 about axis 41. Until the captured image is completely rotated about the axis 41 of the portable computer-readable medium 12 as determined at step 195, it is again compared to the template in its incrementally-rotated orientation. In other words, each captured image is compared at various angular orientations between about zero degrees (0°) to about three hundred sixty degrees (360°) to the template. Incrementally rotating the captured image at step 197 minimizes the possibility of false negatives due to misaligned orientations of the captured image and template. If it is determined at step 195 that the captured image has been compared at various angular orientations between the original orientation and a full rotation of the captured image and no match has been established, then the next template in the library is selected at step 199 so long as it is determined at step 198 that there are more available images in the library to which the captured image has not yet been compared to, and the comparison at step 189 is repeated for that next template. If at step 198 it is determined that the captured image has been compared to all available templates in the library without a match, then a desired position and orientation of the variable label content has not been established, and the routine is exited.

The above steps are repeated until it is determined at step 191 that the captured image matches a template in the library. When such a match is made, the control unit 28 can determine the actual angular orientation of the portable computer-readable medium 12 in the printer tray 50 based in part on the required rotations required to establish the match at step 191 with the template. At step 202, the variable label content to be printed onto the pre-printed label 26 is rotated within the control unit 28 to correspond with the actual orientation of the portable computer-readable medium 12 in the printer tray 50. Such rotation of the variable label content causes the variable label content to be printed on the available surface area 186 of the label 26 not occupied by the fixed label content when printing is initiated at step 205. The result is a reproducible printed label 26 having a known relationship between the variable and fixed label contents, regardless of the angular orientation of the portable computer-readable medium 12 within the printer tray 50 when the label printing is performed.

Alternate embodiments can avoid the steps associated with establishing a desirable orientation between the variable and fixed label content by utilizing orientation-independent fixed label content. According to such embodiments, the publisher 10 can print the orientation-independent fixed label content onto the label 26 provided to the portable computer-readable medium 12. Orientation-independent fixed label content lacks dedicated portions of the label 26 dedicated for variable label content. Instead, the orientation-independent fixed label content can include any fixed label content that is adapted to have the variable label content printed thereon at any location of the label 26. In other words, the orientation-independent fixed label content is such that the position and orientation of the variable label content relative to the fixed label content is immaterial for the finished look of the label 26 provided to the portable computer-readable medium 12. No orienting steps are required to be taken in order to properly print the variable label content in a proper position and orientation relative to the orientation-independent fixed label content.

For example, FIG. 17 shows a portable computer-readable medium 12 in the form of a CD with a label 26 bearing orientation-independent fixed label content. The orientation-independent fixed label content in FIG. 17 includes contact information 260 for the medical facility responsible for generating the electronic data about a periphery of the portable computer-readable medium 12. The orientation-independent fixed label content further includes a graphic 264 radially inward of the periphery of the portable computer-readable medium 12. The graphic 264 can optionally be of photographic quality, as shown in FIG. 17, or it can be a graphical symbol. But regardless of the type of graphic 264, the brightness, contrast, other quality, or any combination thereof, of the graphic 264 can optionally be adjusted to give the graphic 264 a faint, or washed out appearance, making the graphic 264 appear to be in the background, behind the passages 170 of variable label content. The orientation-independent fixed label content

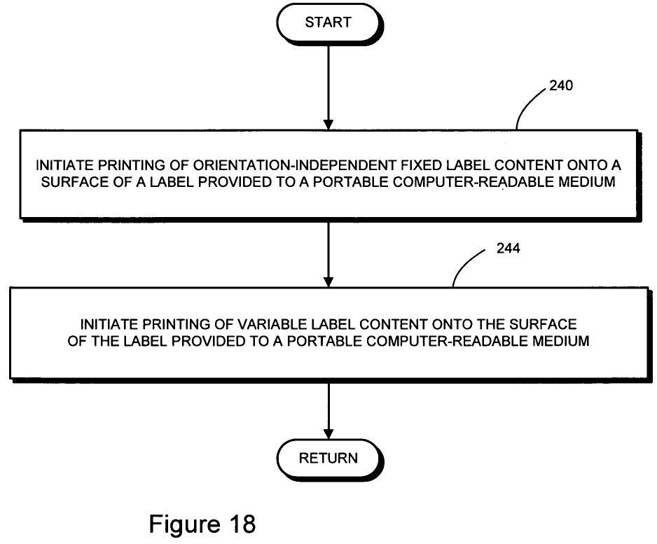

FIG. 18 graphically illustrates steps of a method according to an embodiment of the present invention for providing the portable computer-readable medium 12 with orientation-independent fixed label content. As shown, the printing of the orientation-independent fixed label content onto the label 26 on the portable computer-readable medium 12 is initiated by the control unit 28 of the publisher 10 at step 240. Initiating the printing of the orientation-independent fixed label content is optionally performed earlier in time than the initiation of the variable label content of the label at step 244. Thus, the orientation-independent fixed label content can be printed by the printer 24 at step 240, followed by the printing of the variable label content by the printer 24 at step 244. Alternate embodiments include initiating the printing steps at steps 240 and 244 at approximately the same time such that the printer 24 prints both the orientation-independent fixed label content and the variable label content during the same printing process. The approximately simultaneous printing of such embodiments occurs without printing one label content before the other, and without placing the portable computer-readable medium 12 into the printer tray 50 more than once.

With the portable computer-readable medium 12 published as described above, the end user can retrieve and review the electronic data in a private setting. In addition to the electronic data however, the publisher 10 can also record promotional materials as promotional electronic data onto the portable computer-readable medium 12. The promotional electronic data does not interfere with, nor affect the ability of the end user to retrieve and review the electronic data representing the medical images and documents on the portable computer-readable medium 12. Instead, the promotional electronic data is compatible with viewing applications commonly found on home personal computers, such as Internet Explorer® and Windows Media Player offered by Microsoft, Inc., of Redmond, Wash., Adobe Acrobat Reader, offered by Adobe, Inc., and the like. The promotional materials can advertise a good, service, or a combination of goods and services offered by the medical facility, or any third-party whose software is also recorded onto the portable computer-readable medium 12. Alternately, the promotional materials comprise an advertisement of a service, good or both a service and a good offered by the medical facility from which the electronic data was communicated to the publisher.

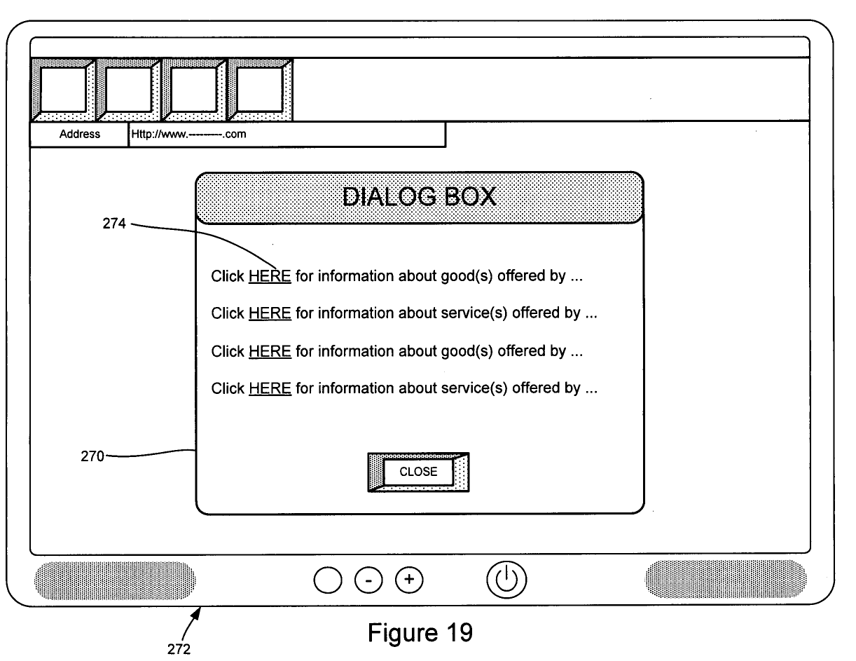

FIG. 19 illustrates an example of how the promotional materials recorded onto the portable computer-readable medium 12 can be displayed to the end user by a monitor 272 provided to a personal computer. As shown, the promotional materials can be displayed in a dialog box 270 that is automatically displayed when the end user inserts the portable computer-readable medium 12 into the personal computer, when the end user attempts to retrieve the electronic data from the portable computer-readable medium 12, when the end user attempts to close the electronic data retrieved from the portable computer-readable medium 12, or at any other suitable moment or combination thereof. The dialog box 270 can include one or more hyperlinks 274 that, when selected by the end user, redirect the end user to a website designated by a party affiliated with the hyperlink selected. A dialog box is a window displayed by the personal computer that contains promotional information, links to promotional information, or a combination thereof. In this way, the end user can optionally be presented with offers of goods and services possibly related to the health of the end user of which the end user was not previously aware.

The method steps are described with specificity hereinabove and shown in the drawings as being performed in a fixed order. However, it should be noted that the order in which the method steps are performed can be altered from this specific order without departing from the scope of the present invention. For example, publication of the portable computer-readable medium 12 is described as recording the electronic data before printing at least the variable label content onto a label 26 provided to the portable computer-readable medium 12. The finished portable computer-readable medium 12 is then retrieved from the printer tray 50 and ejected from the publisher 10. But alternate embodiments can optionally print at least the variable label content onto the label 26 before the electronic data is recorded onto the portable computer-readable medium 12. This is but one example of an arrangement of method steps that differs from that described in detail above, but is still considered to be within the scope of the appended claims.

Illustrative embodiments have been described, hereinabove. It will be apparent to those skilled in the art that the above devices and methods may incorporate changes and modifications without departing from the general scope of this invention. It is intended to include all such modifications and alterations in so far as they come within the scope of the appended claims.

What is claimed is:

1. A publisher for recording electronic data onto a portable computer-readable medium to be given to an end user for allowing the end user to review the electronic data in a private setting, the publisher comprising:
a recorder for recording the electronic data on the portable computer-readable medium;
an automated feeder for supplying the portable computer-readable medium to the recorder without intervention by an operator;
a user interface for visibly displaying options available to the operator for controlling operation of the publisher;
a printer for printing onto a surface of a label at least variable label content that is related to the electronic data that can be retrieved from the computer-readable medium and reviewed by the end user;
a control unit to control the recording of the electronic data onto the computer-readable medium by the recorder;
a communication interface operatively coupled to the control unit for communicating the electronic data to the publisher; and
a computer-accessible memory unit operatively coupled to the publisher and storing computer-executable instructions for performing a method comprising the steps:
determining a quantity of the variable label content to be printed on the label; and
selecting an appropriate label from a plurality of available labels each having different fixed label content as a function of at least the quantity of the variable label content to be printed on the label.

2. The publisher according to claim 1, wherein the printer prints both the variable label content of the label and the fixed label content of the label.

3. The publisher according to claim 1, wherein the printer prints the variable label content on the label and the fixed label content is printed on the label before the variable label content.

4. The publisher according to claim 1, wherein the step of selecting the appropriate label comprises the steps of:
determining a required portion of the label for printing the variable label content; and
selecting the appropriate label from the available labels as a label including a free portion not bearing the fixed label content that is at least as large as the required portion.

5. The publisher according to claim 4, wherein the free portion of the appropriate label most closely matches the required surface area for printing the variable label content.

6. The publisher according to claim 1, wherein the variable label content includes information related to a medical study and the fixed label content includes marketing information.

7. A computer-readable medium comprising computer-executable instructions for performing a method of printing a label related to electronic data stored on a portable computer-readable medium, the method comprising the steps of:
determining a quantity of variable label content specific to the end user to be printed on the label; and
selecting an appropriate label from a plurality of available labels having different fixed label content as a function of at least the quantity of the variable label content to be printed on the label.

8. The computer-readable medium according to claim 7 further comprising computer-executable instructions for performing the step of initiating printing of both the variable label content of the label and the fixed label content of the label onto the portable computer-readable medium.

9. The computer-readable medium according to claim 7 further comprising computer-executable instructions for performing the step of initiating printing of only the variable label content on the portable computer-readable medium, which includes the fixed label content preprinted thereon.

10. The computer-readable medium according to claim 7, wherein the step of selecting the appropriate label comprises the steps of:
determining a required portion of the label for printing the variable label content; and
selecting the appropriate label from the available labels as a label including a free portion not bearing the fixed label content that is at least as large as the required portion.

11. The computer-readable medium according to claim 10, wherein the free portion of the appropriate label most closely matches the required surface area for printing the variable label content.

12. The computer-readable medium according to claim 7, wherein the variable label content includes information related to a medical study and the fixed label content includes marketing information.

13. A publisher for recording electronic data onto a portable computer-readable medium to be given to an end user for allowing the end user to review the electronic data in a private setting, the publisher comprising:
a communication interface operatively coupled to the control unit for communicating the electronic data to the publisher;
a recorder for recording the electronic data on the portable computer-readable medium;
an automated feeder for supplying the portable computer-readable medium to the recorder from a supply bin without intervention by an operator;
a user interface for visibly displaying options that the operator can select to control operation of the publisher;
a printer for printing onto a surface of the portable computer-readable medium at least variable label content related to the electronic data that can be retrieved from the computer-readable medium and reviewed by the end user;
a control unit to control the recording of the electronic data onto the portable computer-readable medium by the recorder; and
a computer-accessible memory unit operatively coupled to the publisher and storing computer-executable instructions for performing a method comprising the steps of:
evaluating an orientation of the portable computer-readable medium introduced to the printer to identify a location of fixed label content preprinted on the surface of the portable computer-readable medium;
determining a location of an available region on the surface of the portable computer-readable medium on which the variable label content is to be printed based at least in part on the location of the fixed label content; and
initiating printing of the variable label content on the available region on the surface of the portable computer-readable medium.

14. The publisher according to claim 13, wherein the step of evaluating the orientation of the portable computer-readable medium introduced to the printer includes the steps of:
acquiring a digital image of the surface of the portable computer-readable medium on which the preprinted fixed label content is printed; and
comparing the digital image of the preprinted fixed label content to at least one pattern in a library of known preprinted fixed label content.

15. The publisher according to claim 13, wherein the step of evaluating the orientation of the portable computer-readable medium introduced to the printer includes the steps of:
locating an index mark provided to the portable computer-readable medium; and
rotating the portable computer-readable medium introduced to the printer so the variable label content is printed on the available region with a predetermined orientation relative to the fixed label content.

16. The publisher according to claim 13, wherein the method further comprises the step of adjusting a layout of the variable label content to be printed on the available region so the variable label content is printed on the available region with a predetermined orientation relative to the fixed label content.

17. A computer-readable medium comprising computer-executable instructions for performing a method of printing on a surface of a portable computer-readable memory variable label content related to data stored on the portable computer-readable medium, the method comprising the steps of:
evaluating an orientation of the portable computer-readable medium as introduced to a printer to identify a location of fixed label content preprinted on the surface of the portable computer-readable medium;
determining a location of an available region on the surface of the computer-readable medium on which the variable label content is to be printed based at least in part on the location of the fixed label content; and
initiating printing of the variable label content on the available region on the surface of the computer-readable medium.

18. The computer-readable medium according to claim 17, wherein the step of evaluating the orientation of the portable computer-readable medium introduced to the printer includes the steps of:
acquiring a digital image of the surface of the portable computer-readable medium on which the preprinted fixed label content is printed; and
comparing the digital image of the preprinted fixed label content to patterns in a library of known preprinted fixed label content.

19. The computer-readable medium according to claim 17, wherein the step of evaluating the orientation of the portable computer-readable medium introduced to the printer includes the steps of:
locating an index mark provided to the portable computer-readable medium; and
rotating the portable computer-readable medium introduced to the printer so the variable label content is printed on the available region with a predetermined orientation relative to the fixed label content.

20. The computer-readable medium according to claim 17, wherein the method further comprises the step of adjusting a layout of the variable label content to be printed on the available region so the variable label content is printed on the available region with a predetermined orientation relative to the fixed label content.

21. A publisher for recording electronic data onto a portable computer-readable medium to be given to an end user for allowing the end user to review the electronic data in a private setting, the publisher comprising:
a recorder for recording the electronic data on the portable computer-readable medium;
an automated feeder for supplying the portable computer-readable medium to the recorder without intervention by an operator;
a user interface for visibly displaying options available to the operator for controlling operation of the publisher;
a printer for printing onto a surface of a label at least variable label content that is related to the electronic data that can be retrieved from the computer-readable medium and reviewed by the end user;
a control unit to control the recording of the electronic data onto the computer-readable medium by the recorder;
a communication interface operatively coupled to the control unit for communicating the electronic data to the publisher; and
a computer-accessible memory unit operatively coupled to the publisher and storing computer-executable instructions for performing a method comprising the steps:
establishing a status of the end user; and
selecting an appropriate fixed label content based at least in part on the status of the end user.

22. The publisher according to claim 21, wherein the step of selecting an appropriate fixed label content comprises the steps of:
selecting a graphical fixed label content when the status of the end user is a customer; and
selecting a blank or minimal graphical fixed label content when the status of the end user is affiliated with a proprietor responsible for recording the electronic data onto the portable computer-readable medium.

23. The publisher according to claim 22, wherein the customer is a patient and the end user affiliated with the proprietor is a medical professional affiliated with a medical facility.

24. The publisher according to claim 22, wherein the label includes a glossy finish when the graphical fixed label content is selected.

25. The publisher according to claim 21, wherein the blank fixed label content requires less ink to print than the graphical fixed label content.

26. The publisher according to claim 21, wherein the blank fixed label content requires less time to print than does the graphical fixed label content.

27. The publisher according to claim 21, wherein the blank fixed label content is printed in black-and-white ink, and the graphical fixed label content includes at least one color other than black and white.

28. The publisher according to claim 21, wherein the label is a side of the portable computer-readable medium opposite the side on which the electronic data is to be recorded.

29. A computer-readable medium comprising computer-executable instructions for performing a method of printing on a surface of a label variable label content related to electronic data stored on a portable computer-readable medium, the method comprising the steps of:
establishing a status of an intended end user of the electronic data on the portable computer-readable medium; and
selecting an appropriate fixed label content based at least in part on the status of the end user.

30. The computer-readable medium according to claim 29, wherein the step of selecting an appropriate label comprises the steps of:
selecting a first available label including external fixed label content when the status of the end user is a customer; and
selecting a second available label including internal fixed label content when the status of the end user is affiliated with a proprietor responsible for recording the electronic data onto the portable computer-readable medium.

31. The computer-readable medium according to claim 30, wherein the customer is a patient and the end user affiliated with the proprietor is a medical professional affiliated with a medical facility.

32. The computer-readable medium according to claim 30, wherein the label is a surface of the portable computer-readable medium.

33. The computer-readable medium according to claim 32, wherein the surface of the computer-readable medium onto which the blank fixed label content is to be printed includes a flat finish and the surface of the computer-readable medium onto which the graphical fixed label content is to be printed includes a glossy finish.

34. The computer-readable medium according to claim 30, wherein the blank fixed label content requires less ink to print than the graphical fixed label content.

35. The computer-readable medium according to claim 30, wherein the blank fixed label content requires less time to print than does the graphical fixed label content.

36. The computer-readable medium according to claim 30, wherein the graphical fixed label content includes at least one color other than black and white.

37. A publisher for recording electronic data onto a portable computer-readable medium to be given to an end user for allowing the end user to review the electronic data with a personal computer in a private setting, the publisher comprising:
a recorder for recording the electronic data on the portable computer-readable medium;
an automated feeder for supplying the portable computer-readable medium to the recorder without intervention by an operator;
a user interface for visibly displaying options available to the operator for controlling operation of the publisher;
a printer for printing onto a surface of a label at least variable label content that is related to the electronic data that can be retrieved from the computer-readable medium and reviewed by the end user;
a control unit to control the recording of the electronic data onto the computer-readable medium by the recorder;
a communication interface operatively coupled to the control unit for communicating the electronic data to the publisher;
a memory interface for receiving a memory module storing third-party computer-executable instructions that facilitate the review of the electronic data by the end user with the personal computer; and
a computer-accessible memory unit operatively coupled to the publisher and storing computer-executable instructions for performing a method comprising the steps of:
searching a predetermined directory of the memory module for selected third-party computer-executable instructions stored by the memory module that facilitate the review of the electronic data with the personal computer; and
recording the selected third-party computer-executable instructions on the portable computer-readable medium.

38. The publisher according to claim 37, wherein the memory interface is selected from the group consisting of: a universal serial bus port, a compact flash port, a memory stick port, a serial port, a parallel port, a microdrive port, and a secure digital port.

39. The publisher according to claim 37, wherein the step of recording the selected third-party computer-executable instructions is performed when the electronic data is recorded to the portable computer-readable medium.

40. The publisher according to claim 37, wherein the selected third-party computer-executable instructions form a software application selected from the group consisting of: a text-document viewer, an image viewer, a visual media viewer, and an audible media player.

41. The publisher according to claim 37, wherein the suitable third-party computer-executable instructions are automatically recorded on the portable computer-readable medium without intervention by the operator.

42. A method of recording electronic data onto a portable computer-readable medium to be reviewed by an end user in a private setting with a personal computer, the method comprising the steps of:
retrieving the electronic data to be recorded onto the portable computer-readable medium and transmitting the electronic data to a publisher;
searching a predetermined directory of a memory module that is removably coupled to the publisher for suitable third-party computer-executable instructions that facilitate the review of the electronic data with the personal computer; and
recording the suitable third-party computer-executable instructions and the electronic data onto the portable computer-readable medium.

43. The method according to claim 42 further comprising the step of presenting an option to an operator of the publisher to record the suitable third-party computer-executable instructions before recording the suitable third-party computer-executable instructions onto the portable computer-readable medium.

44. The method according to claim 42 further comprising the step of manually selecting third-party computer-executable instructions to record onto the portable computer-readable medium.

45. The method according to claim 42, wherein the step of recording the suitable third-party computer-executable instructions is executed automatically by the publisher without intervention by an operator of the publisher.

46. The method according to claim 42 further comprising the step of:
verifying authorization to record the third-party computer-executable instructions onto the portable computer-readable medium before the step of recording the third-party computer-executable instructions is performed.

47. The method according to claim 46, wherein the step of verifying authorization to record the third-party computer-executable instructions comprises the step of confirming a data key of the memory module is authorized to record the third-party computer-executable instructions onto the computer-readable medium to be distributed to the end user.

48. A publisher for recording electronic data stored on a remotely located server onto a portable computer-readable medium to be given to an end user for allowing the end user to review the electronic data with a personal computer in a private setting, the publisher comprising:
a recorder for recording the electronic data on the portable computer-readable medium;
an automated feeder for supplying the portable computer-readable medium to the recorder without intervention by an operator;
a user interface for visibly displaying options available to the operator for controlling operation of the publisher;
a printer for printing onto a surface of a label at least variable label content that is related to the electronic data that can be retrieved from the computer-readable medium and reviewed by the end user;
a control unit to control the recording of the electronic data onto the computer-readable medium by the recorder;
a communication interface operatively coupled to the control unit for communicating the electronic data received from the remotely located server to the publisher; and
a computer-accessible memory unit operatively coupled to the publisher and storing computer-executable instructions for performing a method comprising the steps of:
determining when the transfer of the electronic data from the remotely located server is complete without waiting for a timeout period to expire; and
commencing the recording of the electronic data upon completion of the transfer of the electronic data from the remotely located server.

49. The publisher according to claim 48, wherein the step of determining when the transfer for the electronic data is complete comprises the step of performing a query of the remotely located server to determine a quantity of the electronic data to be transferred.

50. The publisher according to claim 49, wherein the query returns a number of image files to be transferred from the remotely located server to be recorded onto the computer-readable medium.

51. The publisher according to claim 49, wherein the image files include at least one image selected from the group consisting of a digitized x-ray, digital x-ray, CT scan, MRI scan, PET scan, and a chart.

52. A computer-readable medium comprising computer-executable instructions for performing a method of recording electronic data stored on a remotely located server onto a portable computer-readable media, the method comprising the steps of:
initiating communication of the electronic data from the remotely located server to a computer-readable media publisher;
determining when the communication of the electronic data from the remotely located server to the publisher is complete without waiting for a timeout period to expire; and
commencing the recording of the electronic data upon completion of the transfer of the electronic data from the remotely located server.

53. The computer-readable medium according to claim 52, wherein the step of determining when the communication of the electronic data is complete comprises the step of querying the remotely located server to determine a quantity of the electronic data that is to be transferred.

54. The computer-readable medium according to claim 53, wherein the query returns a number of image files to be transferred from the remotely located server to be recorded onto the portable computer-readable medium.

55. The computer-readable medium according to claim 54, wherein the image files include at least one image selected from the group consisting of a digitized x-ray, digital x-ray, CT scan, MRI scan, PET scan, and a chart.

56. A publisher for recording electronic data onto a portable computer-readable medium to be given to an end user for allowing the end user to review the electronic data in a private setting, the publisher comprising:
a recorder for recording the electronic data on the portable computer-readable medium;
an automated feeder for supplying the portable computer-readable medium to the recorder without intervention by an operator;
a user interface presenting the operator with one or more options that the operator can select to enter a command for controlling operation of the publisher;
a printer for printing onto a surface of a label at least variable label content that is related to the electronic data that can be retrieved from the computer-readable medium and reviewed by the end user;
a control unit to control the recording of the electronic data onto the portable computer-readable medium by the recorder;
a communication interface operatively coupled to the control unit for communicating the electronic data to the publisher; and
a recording interface for establishing a communication path between the publisher and an external recording device for substantially-continuously recording the electronic data onto the external recording device as the electronic data is communicated to the publisher.

57. The publisher according to claim 56, wherein the recording interface is compatible with one or more of the external memory devices selected from the group consisting of: a universal serial bus flash drive, a portable digital audio player, a cellular telephone, a microdrive, a compact flash card, and a secure digital card.

58. The publisher according to claim 56, wherein recording the electronic data onto the external recording device is independent of the recording of the electronic data onto the portable computer-readable medium.

59. A method of recording electronic data onto a portable computer-readable medium to be given to an end user for allowing the end user to review the electronic data in a private setting, the method comprising the steps of:
communicating the electronic data to be recorded onto the portable computer-readable medium to a computer-readable media publisher;
supplying the portable computer-readable medium to a recorder of the publisher automatically without intervention by an operator;
recording the electronic data onto the portable computer-readable medium upon receiving a record command from the operator; and
substantially-continuously recording the electronic data onto an external recording device automatically as the electronic data is communicated to the publisher without intervention by the operator.

60. The method according to claim 59, wherein recording of the electronic data onto the external recording device commences before all electronic data to be recorded is received by the computer-readable media publisher.

61. The method according to claim 59, wherein recording of the electronic data onto the external recording device commences once a predetermined portion of the electronic data to be recorded is communicated to the computer-readable-media publisher.

62. The method according to claim 61, wherein the predetermined portion of the electronic data collectively represents one image out of a plurality of images to be communicated as electronic data to the computer-readable-media publisher.

63. The method according to claim 59, wherein the electronic data is recorded onto the external recording device substantially simultaneously as it is received by the computer-readable-media publisher.

64. The method according to claim 59 further comprising the steps of:
searching a predetermined directory of a memory module that is removably coupled to the computer-readable-media publisher for selected third-party computer-executable instructions that facilitate the review of the electronic data with a personal computer; and
automatically recording the selected third-party computer-executable instructions and the electronic data onto the portable computer-readable medium without intervention by the operator.

65. A publisher for recording electronic data onto a portable computer-readable medium to be given to an end user for allowing the end user to review the electronic data in a private setting with a personal computer, the publisher comprising:
a recorder for recording the electronic data on the portable computer-readable medium;
an automated feeder for supplying the portable computer-readable medium to the recorder without intervention by an operator;
a touch-screen interface visually displaying to the operator one or more options that the operator can select by contacting the touch-screen interface to enter a command for controlling operation of the publisher;
a printer for printing onto a surface of a label at least variable label content that is related to the electronic data that can be retrieved from the computer-readable medium and reviewed by the end user;
a control unit to control the recording of the electronic data onto the portable computer-readable medium by the recorder; and
a communication interface operatively coupled to the control unit for communicating the electronic data to the publisher.

66. The publisher according to claim 65, wherein all available commands for controlling operation of the publisher can be entered by the operator with the touch-screen interface without external peripherals being operatively coupled to the publisher.

67. The publisher according to claim 66, wherein the recorder, automated feeder, touch-screen interface, printer, control unit, and communication interface are integrally formed as a single unit.

68. The publisher according to claim 66, wherein at least the recorder, printer and the control unit are vertically stacked to minimize a surface area upon which the publisher rests.

69. A publisher for recording electronic data onto a portable computer-readable medium to be given to an end user for allowing the end user to review the electronic data in a private setting with a personal computer, the publisher comprising:
a recorder for recording the electronic data on the portable computer-readable medium;
an automated feeder for supplying the portable computer-readable medium to the recorder without intervention by an operator;
a user interface presenting the operator with one or more options that the operator can select to enter a command for controlling operation of the publisher;
a printer for printing onto a surface of a label at least variable label content that is related to the electronic data that can be retrieved from the computer-readable medium and reviewed by the end user;
a control unit to control the recording of the electronic data onto the portable computer-readable medium by the recorder; and
a communication interface operatively coupled to the control unit for communicating the electronic data to the publisher, wherein
the recorder, automated feeder, user interface and control unit are vertically stacked and integrally formed as a single unit to minimize a surface area upon which the publisher rests.

70. The publisher according to claim 69, wherein the printer is vertically stacked with the recorder, automated feeder, user interface and control unit.

71. The publisher according to claim 69, wherein the publisher lacks external peripherals for controlling operation of the publisher and all control commands are input to control operation of the publisher with the integrated user interface.

72. The publisher according to claim 71, wherein the user interface includes a touch-screen display panel.

73. A publisher for recording electronic data onto a portable computer-readable medium to be given to an end user for allowing the end user to review the electronic data in a private setting with a personal computer, the publisher comprising:
a recorder for recording the electronic data on the portable computer-readable medium;
an automated feeder for supplying the portable computer-readable medium to the recorder without intervention by an operator;
a user interface presenting the operator with one or more options that the operator can select to enter a command for controlling operation of the publisher;
a printer for printing onto a surface of a label at least variable label content that is related to the electronic data that can be retrieved from the computer-readable medium and reviewed by the end user;
a control unit to control the recording of the electronic data onto the portable computer-readable medium by the recorder;
a communication interface operatively coupled to the control unit for communicating the electronic data to the publisher; and
an image printer for printing a hardcopy of an image represented by the electronic data.

74. The publisher according to claim 73, wherein the image printer has a plurality of predetermined profiles that each define at least one or more settings selected from the group consisting of image media type, image media size, page layout, and image settings.

75. The publisher according to claim 73, wherein the user interface comprises a selective print option that, when selected, initiates printing of a hardcopy of at least a select image from among a plurality of available images represented by the electronic data.

76. The publisher according to claim 73, wherein the user interface comprises a complete print option that, when selected, initiates printing of hardcopies of all images represented by the electronic data.

77. The publisher according to claim 73 further comprising a computer-accessible memory unit operatively coupled to the publisher and storing computer-executable instructions for performing a method comprising the step of mapping an image represented by the electronic data to a printable image format to be printed by the image printer.

78. The publisher according to claim 77, wherein the step of mapping the image is performed automatically without intervention by an operator.

79. The publisher according to claim 78, wherein the image is mapped according to a profile of the image printer.

80. The publisher according to claim 77, wherein the mapping of the image is performed according to formatting commands manually input to the publisher by the operator.

81. The publisher according to claim 77, wherein the mapping defines grayscale levels of the hardcopy to be printed with the image printer.

82. A publisher for recording electronic data onto a portable computer-readable medium to be given to an end user for allowing the end user to review the electronic data in a private setting with a personal computer, the publisher comprising:
a recorder for recording the electronic data on the portable computer-readable medium;
an automated feeder for supplying the portable computer-readable medium to the recorder without intervention by an operator;
a user interface presenting the operator with one or more options that the operator can select to enter a command for controlling operation of the publisher;
a printer for printing onto a surface of a label at least variable label content that is related to the electronic data that can be retrieved from the computer-readable medium and reviewed by the end user;
a control unit to control the recording of the electronic data onto the portable computer-readable medium by the recorder;
a communication interface operatively coupled to the control unit for communicating the electronic data to the publisher; and
a computer-accessible memory unit operatively coupled to the publisher and storing computer-executable instructions for performing a method comprising the steps of:
affiliating a label format to be printed onto the label with a job profile selected by the operator;
affiliating site-specific label content with a site profile referenced by the job profile selected by the operator that corresponds to a facility from which the electronic data is communicated to the publisher; and
initiating printing of both the label format corresponding to the selected job profile and the site-specific label content and the fixed label content onto the label.

83. The publisher according to claim 82, wherein the communication interface communicates the electronic data from a local area network to the publisher.

84. The publisher according to claim 82, wherein the communication interface communicates the electronic data from a wide area network to the publisher.

85. The publisher according to claim 82, wherein the publisher is enclosed within a mobile housing to be relocated to different medical facilities.

86. The publisher according to claim 82 further comprising computer-executable instructions for performing the steps of:
searching a predetermined directory of a memory module that is removably coupled to the publisher for selected third-party computer-executable instructions that facilitate the review of the electronic data with a personal computer; and
automatically recording the selected third-party computer-executable instructions and the electronic data onto the portable computer-readable medium without intervention by the operator.

87. A publisher for recording electronic data onto a portable computer-readable medium to be given to an end user for allowing the end user to review the electronic data in a private setting with a personal computer, the publisher comprising:
a recorder for recording the electronic data on the portable computer-readable medium;
an automated feeder for supplying the portable computer-readable medium to the recorder without intervention by an operator;
a user interface presenting the operator with one or more options that the operator can select to enter a command for controlling operation of the publisher, wherein
the user interface presents the operator with a quick record option which, when selected, initiates publishing of the electronic data onto the portable computer-readable medium without further intervention by the operator;
a printer for printing onto a surface of a label at least variable label content that is related to the electronic data that can be retrieved from the computer-readable medium and reviewed by the end user;
a control unit to control the recording of the electronic data onto the portable computer-readable medium by the recorder; and
a communication interface operatively coupled to the control unit for communicating the electronic data to the publisher.

88. The publisher according to claim 87, wherein the user interface displays the quick record option for a study including one or more images, and when selected, the quick record option initiates recording of all images within the study without further intervention by the operator.

89. A publisher for recording electronic data onto a portable computer-readable medium to be given to an end user for allowing the end user to review the electronic data in a private setting with a personal computer, the publisher comprising:
a recorder for recording the electronic data on the portable computer-readable medium;
an automated feeder for supplying the portable computer-readable medium to the recorder without intervention by an operator;
a user interface presenting the operator with one or more options that the operator can select to enter a command for controlling operation of the publisher;
a printer for printing onto a surface of a label at least variable label content that is related to the electronic data that can be retrieved from the computer-readable medium and reviewed by the end user;
a control unit to control the recording of the electronic data onto the portable computer-readable medium by the recorder;
a communication interface operatively coupled to the control unit for communicating the electronic data to the publisher; and
a computer-accessible memory unit operatively coupled to the publisher and storing computer-executable instructions for performing a method comprising the steps of:
initiating printing of orientation-independent fixed label content onto the surface of the label; and
initiating printing of the variable label content onto the surface of the label without regard to an orientation of the computer-readable medium during printing.

90. The publisher according to claim 89, wherein initiation of the printing of the orientation-independent fixed label content occurs before the initiation of the printing of the variable label content.

91. The publisher according to claim 89, wherein initiation of the printing of the orientation-independent fixed label content occurs approximately simultaneously as the initiation of the printing of the variable label content.

92. The publisher according to claim 89, wherein the orientation-independent fixed label content comprises textual information related to a facility from which the electronic data was communicated to the publisher about a periphery of the portable computer-readable medium.

93. The publisher according to claim 92, wherein the orientation-independent fixed label content further comprises a background graphic.

94. A publisher for recording electronic data onto a portable computer-readable medium to be given to an end user for allowing the end user to review the electronic data in a private setting with a personal computer, the publisher comprising:
a recorder for recording the electronic data on the portable computer-readable medium;
an automated feeder for supplying the portable computer-readable medium to the recorder without intervention by an operator;
a user interface presenting the operator with one or more options that the operator can select to enter a command for controlling operation of the publisher;
a printer for printing onto a surface of a label at least variable label content that is related to the electronic data that can be retrieved from the computer-readable medium and reviewed by the end user;
a control unit to control the recording of the electronic data onto the portable computer-readable medium by the recorder;
a communication interface operatively coupled to the control unit for communicating the electronic data to the publisher; and
a computer-accessible memory unit operatively coupled to the publisher and storing computer-executable instructions for performing a method comprising the steps of:
initiating recording of the electronic data onto the portable computer-readable medium; and
initiating recording of computer-executable logic onto the portable computer-readable medium for causing the personal computer to display promotional material to the end user.

95. The publisher according to claim 94, wherein the computer-executable logic causes the personal computer to display the promotional material to the end user as a dialog box before the electronic data is displayed by the personal computer.

96. The publisher according to claim 94, wherein the computer-executable logic causes the personal computer to display the promotional material to the end user as a dialog box after the electronic data ceases to be displayed by the personal computer.

97. The publisher according to claim 94, wherein the promotional material comprises an advertisement of a service, good or both a service and a good offered by a facility from which the electronic data was communicated to the publisher.

98. The publisher according to claim 94, wherein the promotional material comprises an advertisement of a service, good or both a service and a good offered by a third-party provider of software recorded on the portable computer-readable medium that facilitates review of the electronic data by the end user.

99. A publisher for recording electronic data onto a portable computer-readable medium to be given to an end user for allowing the end user to review the electronic data in a private setting with a personal computer, the publisher comprising:
a recorder for recording the electronic data on the portable computer-readable medium;
an automated feeder for supplying the portable computer-readable medium to the recorder without intervention by an operator;
a user interface presenting the operator with one or more options that the operator can select to enter a command for controlling operation of the publisher;
a printer for printing onto a surface of a label at least variable label content that is related to the electronic data that can be retrieved from the computer-readable medium and reviewed by the end user;
a control unit to control the recording of the electronic data onto the portable computer-readable medium by the recorder;
a communication interface operatively coupled to the control unit for communicating the electronic data to the publisher; and
a computer-accessible memory unit operatively coupled to the publisher and storing computer-executable instructions for performing a method comprising the steps of:
analyzing electronic data forming a portion of a study that has been communicated to the publisher from a remotely-located server to identify the study; and
requesting the electronic data of the study from the remotely-located server.

100. The publisher according to claim 99, wherein the quantity of electronic data is transmitted from the remotely-located server without a request from the publisher.

101. The publisher according to claim 100 further comprising the step of deleting the electronic data from the study that was transmitted from the remotely-located server.

102. The publisher according to claim 100 further comprising the step of receiving, but not recording the electronic data from the study that was transmitted from the remotely-located server.
